(19) United States
(12) Patent Application Publication
(10) Pub. No.: US 2024/0387864 A1
(43) Pub. Date: Nov. 21, 2024

(54) COMPOSITE, BATTERY, AND ELECTRONIC APPARATUS

(71) Applicant: SEIKO EPSON CORPORATION, TOKYO (JP)

(72) Inventors: Hitoshi YAMAMOTO, Chino-shi (JP); Tsutomu TERAOKA, Matsumoto-shi (JP); Hirohisa FUJIMORI, SHIOJIRI-SHI (JP)

(21) Appl. No.: 18/664,452

(22) Filed: May 15, 2024

(30) Foreign Application Priority Data
May 15, 2023 (JP) 2023-080391

(51) Int. Cl. H01M 10/0562

(52) U.S. Cl. CPC H01M 10/0562; H01M 2300/0071; H01M 2300/0094

(57) ABSTRACT

A composite according to the present disclosure includes an active material, a crystalline first electrolyte portion containing a lithium composite metal oxide represented by Formula (1), and a second electrolyte portion containing a lithium composite metal oxide represented by Formula (2) and configured to cover at least a part of a surface of the active material. At least a part of the first electrolyte portion is bonded to the active material through the second electrolyte portion,

(Li_{7-3x+y}Gaₓ) (La_{3-y}Ca_{y}) Zr₂O₁₂ (1)

in which 0.10≤x≤1.00, and 0.00<y≤0.30, and

Li_{7-z}La₃(Zr_{2-z}M_{z})O₁₂ (2)

in which the element M is two or more elements selected from the group consisting of Nb, Ta, and Sb, and 0.00<z<2.00.

The present application is based on, and claims priority from JP Application Serial Number 2023-080391, filed May 15, 2023, the disclosure of which is hereby incorporated by reference herein in its entirety.

### BACKGROUND

### 1. Technical Field

The present disclosure relates to a composite, a battery, and an electronic apparatus.

### 2. Related Art

Lithium-ion batteries (including primary batteries and secondary batteries) are used as power sources for many electronic apparatuses including portable information apparatuses. Among these, as a lithium-ion battery achieving both high energy density and safety, an all-solid-state lithium-ion battery using a solid electrolyte for conduction of lithium between positive and negative electrodes is proposed (for example, see JP-A-2009-215130).

The solid electrolyte attracts attention as a highly safe material since conduction of lithium ions is possible without using an organic electrolytic solution and leakage of the electrolytic solution, of volatilization the electrolytic solution due to drive heat generation, or the like does not occur.

As the solid electrolyte used in such an all-solid-state lithium-ion battery, an oxide-based solid electrolyte is widely known, which has high lithium-ion conductivity, excellent insulation properties, and high chemical stability. As such an oxide, a lithium lanthanum zirconate-based material has a remarkably high lithium ion electrical conductivity, and application thereof to a battery has been expected.

JP-A-2009-215130 is an example of the related art.

However, when such a solid electrolyte is used, adhesion between the solid electrolyte and an active material or adhesion between solid electrolyte particles may not be sufficiently excellent, grain-boundary resistance may increase, and lithium-ion conductivity may decrease. As a result, discharging capacity tends to decrease, and in particular, a retention ratio of the discharging capacity tends to decrease when charging and discharging are repeated.

### SUMMARY

A composite according to an application example of the present disclosure includes:
an active material;
a crystalline first electrolyte portion containing a lithium composite metal oxide represented by the following composition formula (1); and
a second electrolyte portion containing a lithium composite metal oxide represented by the following composition formula (2) and configured to cover at least a part of a surface of the active material, in which
at least a part of the first electrolyte portion is bonded to the active material through the second electrolyte portion,

(Li_{7-3x+y}Gaₓ) (La_{3-y}Ca_{y}) Zr₂O₁₂ (1)

in which 0.10≤x≤1.00, and 0.00<y≤0.30, and

Li_{7-z}La₃(Zr_{2-z}M_{z})O₁₂ (2)

in which the element M is two or more elements selected from the group consisting of Nb, Ta, and Sb, and 0.00<z<2.00.

A battery according to an application example of the present disclosure includes:
the composite according to the application example of the present disclosure;
an electrode provided at one surface side of the composite; and
a current collector provided at the other surface side of the composite.

An electronic apparatus according to an application example of the present disclosure includes the battery according to the application example of the present disclosure.

### BRIEF DESCRIPTION OF THE DRAWINGS

FIG. 1 is an enlarged cross-sectional view schematically showing an example of a composite according to the present disclosure.

FIG. 2 is a schematic cross-sectional view schematically showing a structure of a lithium-ion secondary battery.

FIG. 3 is a perspective view showing a configuration of a wearable apparatus as an electronic apparatus.

FIG. 4 is a table collectively showing conditions of composites in Examples A1 to A16 and heating temperatures in a firing treatment.

FIG. 5 is a table collectively showing conditions of composites in Examples A17 to A19 and Comparative Examples A1 to A12 and heating temperatures in a firing treatment.

FIG. 6 is a table collectively showing evaluation results of the composites in Examples A1 to A16.

FIG. 7 is a table collectively showing evaluation results of composites in Examples A17 to A19 and Comparative Examples A1 to A12.

FIG. 8 is a table collectively showing evaluation results of batteries in Examples B1 to B16.

FIG. 9 is a table collectively showing evaluation results of batteries in Examples B17 to B19 and Comparative Examples B1 to B12.

### DESCRIPTION OF EMBODIMENTS

Hereinafter, a preferred embodiment according to the present disclosure will be described in detail.

### 1 Composite

First, a composite according to the present disclosure will be described.

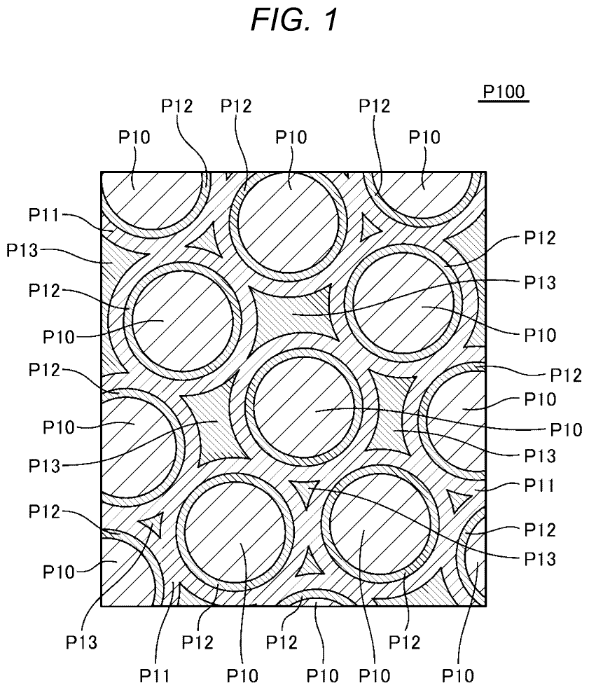

FIG. 1 is an enlarged cross-sectional view schematically showing an example of the composite according to the present disclosure.

As shown in FIG. 1, a composite P100 includes active materials P10, crystalline first electrolyte portions P11, and second electrolyte portions P12 each covering at least a part of a surface of the active material P10. At least a part of the first electrolyte portion P11 is bonded to the active material P10 through the second electrolyte portion P12.

In other words, the composite P100 includes the active materials P10, the crystalline first electrolyte portions P11 each containing a lithium composite metal oxide represented by the following composition formula (1), and the second electrolyte portions P12 each containing a lithium composite metal oxide represented by the following composition formula (2) and configured to cover at least a part of the surface of the active material P10. That is, the second electrolyte portion P12 is interposed between the active material P10 and the first electrolyte portion P11.

The first electrolyte portion P11 contains the lithium composite metal oxide represented by the following composition formula (1). The second electrolyte portion P12 contains the lithium composite metal oxide represented by the following composition formula (2),

(Li_{7-3x+y}Gaₓ) (La_{3-y}Ca_{y}) Zr₂O₁₂ (1)

in which 0.10≤x≤1.00, and 0.00<y≤0.30, and

Li_{7-z}La₃(Zr_{2-z}M_{z})O₁₂ (2)

in which the element M is two or more elements selected from the group consisting of Nb, Ta, and Sb, and 0.00<z<2.00.

According to such a configuration, it is possible to provide a composite in which adhesion between a solid electrolyte and the active material or adhesion between the solid electrolyte is sufficiently excellent, an increase in grain-boundary resistance is prevented, and a decrease in lithium-ion conductivity is prevented. Further, by using such a composite, it is possible to provide a battery whose discharging capacity is less likely to decrease, and in particular, the discharging capacity is suitably maintained even when charging and discharging are repeated.

In contrast, when the above conditions are not satisfied, satisfactory results cannot be obtained.

For example, even when the active material and a portion corresponding to the first electrolyte portion are provided, when a portion corresponding to the second electrolyte portion is not provided, adhesion between the active material and the portion corresponding to the first electrolyte portion deteriorates, the grain-boundary resistance increases, and the lithium-ion conductivity deteriorates. As a result, when being applied to a battery, the discharging capacity tends to decrease, and in particular, a retention ratio of the discharging capacity tends to decrease when charging and discharging are repeated.

When the portion corresponding to the first electrolyte portion is formed of another electrolyte instead of the lithium composite metal oxide represented by Composition Formula (1), the adhesion between the active material and the portion corresponding to the first electrolyte portion cannot be sufficiently excellent, the grain-boundary resistance increases, and the lithium-ion conductivity cannot be made sufficiently excellent. As a result, when being applied to a battery, the discharging capacity tends to decrease, and in particular, a retention ratio of the discharging capacity tends to decrease when charging and discharging are repeated.

In particular, when the electrolyte constituting the portion corresponding to the first electrolyte portion has a composition in which x in Composition Formula (1) is less than the lower limit value, the lithium-ion conductivity, in particular, particle bulk conductivity significantly decreases.

When the electrolyte constituting the portion corresponding to the first electrolyte portion has a composition in which x in Composition Formula (1) exceeds the upper limit value, Ga (gallium) may not enter a crystal lattice of the electrolyte, a gallium oxide having high insulation properties may be generated, and total lithium-ion conductivity may decrease.

When the electrolyte constituting the portion corresponding to the first electrolyte portion has a composition in which y in Composition Formula (1) is 0, that is, when Ca is not contained, the lithium-ion conductivity significantly decreases.

When the electrolyte constituting the portion corresponding to the first electrolyte portion has a composition in which y in Composition Formula (1) exceeds the upper limit value, Ca may not enter the crystal lattice of the electrolyte, a calcium oxide having high insulation properties may be generated, and the total lithium-ion conductivity may decrease.

When the portion corresponding to the second electrolyte portion is formed of another electrolyte instead of the lithium composite metal oxide represented by Composition Formula (2), the adhesion between the active material and the portion corresponding to the first electrolyte portion cannot be sufficiently excellent, the grain-boundary resistance increases, and the lithium-ion conductivity cannot be made sufficiently excellent. As a result, when being applied to a battery, the discharging capacity tends to decrease, and in particular, a retention ratio of the discharging capacity tends to decrease when charging and discharging are repeated.

In particular, when the electrolyte constituting the portion corresponding to the second electrolyte portion has a composition in which z in Composition Formula (2) is 0.00, that is, a composition in which there is no element M, it is difficult to sufficiently increase initial total ion conductivity even when a decrease in total ion conductivity when exposed to the atmosphere can be prevented.

When the electrolyte constituting the portion corresponding to the second electrolyte portion has a composition in which z in Composition Formula (2) is 2.00 or more, it is difficult to sufficiently increase the initial total ion conductivity even when the decrease in total ion conductivity when exposed to the atmosphere can be prevented.

When the portion corresponding to the second electrolyte portion is formed of another electrolyte instead of the lithium composite metal oxide represented by Composition Formula (2), it is difficult to sufficiently increase the initial total ion conductivity even when the decrease in total ion conductivity when exposed to the atmosphere can be prevented. In such a case, examples of the electrolyte constituting the portion corresponding to the second electrolyte portion include an electrolyte in which the element M in Composition Formula (2) is only one type selected from the group consisting of Nb, Ta, and Sb.

### 1-1 Active Material

The active material P10 constituting the composite P100 may be a negative electrode active material or a positive electrode active material.

Examples of the negative electrode active material include a lithium double oxide such as Nb₂O₅, V₂O₅, TiO₂, In₂O₃, Zno, SnO₂, Nio, ITO, AZO, GZO, ATO, FTO, Li₄Ti₅O₁₂, and Li₂Ti₃O₇. Examples thereof further include metals and alloys such as Li, A1, Si, Si—Mn, Si—Co, Si—Ni, Sn, Zn, Sb, Bi, In, and Au, carbon materials, and substances in which the lithium ions are inserted between layers of the carbon materials LiC₂₄ and LiC₆.

Examples of the positive electrode active material include an oxide containing Li and O, more specifically, a lithium double oxide containing at least Li and formed of one or more elements selected from the group consisting of V, Cr, Mn, Fe, Co, Ni, and Cu. Examples of such a double oxide include a composite metal compound containing lithium (Li) and containing one or more elements selected from vanadium (V), chromium (Cr), manganese (Mn), iron (Fe), cobalt (Co), nickel (Ni), and copper (Cu). Examples of such a lithium double oxide include LiCoO₂, LiNiO₂, LiMn₂O₄, Li₂Mn₂O₃, NMC (Liₚ(NiₓMn_{1-x-y}CO_{y})O₂), NCA (Li(NiₓCo_{y}Al_{1-x-y})O₂), LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and LiMnSiO₄. In addition, a part of atoms in a crystal of the lithium double oxide as described above may be a solid solution substituted with another transition metal, a typical metal, an alkali metal, an alkali rare earth, a lanthanoid, a chalcogenide, a halogen, or the like. Examples of the positive electrode active material include a fluoride such as LiFeF₃, a boride complex compound such as LiBH₄ or Li₄BN₃H₁₀, an iodide complex compound such as a polyvinylpyridine-iodine composite, and a non-metal compound such as sulfur.

The active material P10 is preferably a positive electrode active material, more preferably a positive electrode active material containing Li, and still more preferably a lithium double oxide.

Accordingly, adhesion between the active material P10 and the second electrolyte portion P12 can be made more excellent. In addition, it is possible to further improve a charging and discharging performance under high load of a battery including the composite P100.

A coating layer may be formed at the surface of the active material P10 to reduce an interface resistance with the solid electrolyte, particularly the second electrolyte portion P12 and to improve electronic conductivity. For example, by forming a thin film of LiNbO₃, Al₂O₃, ZrO₂, Ta₂O₅ or the like at a surface of the positive electrode active material formed of LiCoO₂, the interface resistance of lithium-ion conduction can be further reduced. A thickness of the coating layers is not particularly limited and is preferably 3 nm or more and 1 μm or less.

The active material P10 may be, for example, a porous body having pores therein, and may have any shape such as a spherical shape, a scale-like shape, an amorphous shape, a columnar shape, a plate shape, a sheet shape, a chip shape, a pellet shape, or a block shape. In the shown configuration, the active material P10 has a particle shape.

When the active material P10 has a particle shape, an average particle diameter of the active material P10 is not particularly limited, and is preferably 0.1 μm or more and 150 μm or less, more preferably 0.3 μm or more and 10 μm or less, and still more preferably 0.5 μm or more and 5 μm or less.

Accordingly, it is easy to achieve both an actual capacity density close to a theoretical capacity of the active material P10 and a high charging and discharging rate.

In the present specification, the average particle diameter refers to an average particle diameter on a volume basis and can be obtained by, for example, adding a sample into methanol and measuring a dispersion liquid, which is dispersed for 3 minutes by an ultrasonic disperser, by a Coulter counter method particle size distribution measurement device (TA-II type manufactured by COULTER ELECTRONICS Inc.) with an aperture of 50 μm.

A particle size distribution of the active material P10 is not particularly limited, and for example, in the particle size distribution having one peak, a half width of the peak can be set to 0.1 μm or more and 19 μm or less. The particle size distribution of the active material may have two or more peaks.

A bulk density of the active material P10 is preferably 50% or more and 90% or less, and more preferably 50% or more and 70% or less.

Accordingly, a surface area in the pore of the active material P10 increases, a contact area between the active material P10 and the electrolyte, in particular, the second electrolyte portion P12 tends to increase, and it is easy to further increase the capacity in a battery including the composite P100.

When the bulk density is B (%), an apparent volume including the pores of the active material P10 is v, a mass of the active material P10 is w, and a particle density of the active material P10 is p, the following formula (a) holds. Accordingly, the bulk density can be obtained.

$$β = \{ w / ( v \cdot ρ ) \} \times 100 \qquad ( a )$$

A resistivity of the active material P10 is preferably 700 Ω·cm or less.

Accordingly, a more excellent C rate (charging and discharging speed) can be obtained in the battery including the composite P100.

The resistivity can be obtained by, for example, causing a copper foil as an electrode to adhere to the surface of the active material P10 and performing DC polarization measurement.

A proportion of the active material P10 in the composite P100 is preferably 25 mass % or more and 75 mass % or less, more preferably 30 mass % or more and 70 mass % or less, and still more preferably 40 mass % or more and 60 mass % or less.

Accordingly, a battery having a particularly excellent balance between the battery capacity and the C rate (charging and discharging speed) can be obtained.

### 1-2 First Electrolyte Portion

The composite P100 includes the crystalline first electrolyte portion P11 containing the lithium composite metal oxide represented by Composition Formula (1). In the following description, the lithium composite metal oxide represented by Composition Formula (1) is also referred to as a “first solid electrolyte”.

In Composition Formula (1), it is sufficient that 0.10≤x≤1.00, but preferably 0.20≤x≤1.00, more preferably 0.20≤x≤0.90, and still more preferably 0.20≤x≤0.80.

Accordingly, the above-described effects are remarkably exerted. In addition, affinity and adhesion between the first electrolyte portion P11 and the second electrolyte portion P12 can be made more excellent.

In Composition Formula (1), it is sufficient that 0.00<y≤0.30, but preferably 0.01≤y≤0.27, more preferably 0.02≤y≤0.24, and still more preferably 0.03≤y≤0.20.

Accordingly, the above-described effects are remarkably exerted. In addition, affinity and adhesion between the first electrolyte portion P11 and the second electrolyte portion P12 can be made more excellent.

The first solid electrolyte constituting the first electrolyte portion P11 may contain another element, for example, elements other than Li, Ga, La, Ca, Zr, and O by only a minute amount, in addition to the elements constituting Composition Formula (1). The another element may be one type or two or more types.

A content of the another element contained in the first solid electrolyte is preferably 100 ppm or less, and more preferably 50 ppm or less.

When two or more elements are contained as the another element, a sum of contents of the elements is adopted as the content of the another element.

It is sufficient that the first electrolyte portion P11 contains the first solid electrolyte, and may further contain a component other than the first solid electrolyte.

A content of the component other than the first solid electrolyte in the first electrolyte portion P11 is preferably 5.0 mass % or less, more preferably 3.0 mass % or less, and still more preferably 1.0 mass % or less.

A proportion of the first electrolyte portion P11 in the composite P100 is preferably 25 mass % or more and 75 mass % or less, more preferably 30 mass % or more and 70 mass % or less, and still more preferably 40 mass % or more and 60 mass % or less.

Accordingly, a battery having a particularly excellent balance between the battery capacity and the C rate (charging and discharging speed) can be obtained.

### 1-3 Second Electrolyte Portion

The composite P100 includes the second electrolyte portion P12 containing the lithium composite metal oxide represented by Composition Formula (2). In the following description, the lithium composite metal oxide represented by Composition Formula (2) is also referred to as a “second solid electrolyte”. For convenience, FIG. 1 shows that the entire surface of the active material P10 is covered with the second electrolyte portion P12, and it is sufficient that at least a part of the surface of the active material P10 is covered.

In Composition Formula (2), it is sufficient that 0.00<z<2.00, but preferably 0.20≤z≤1.80, more preferably 0.40≤z≤1.50, and still more preferably 0.50≤z≤1.30.

Accordingly, above-described effects are the remarkably exerted. In addition, affinity and adhesion of the second electrolyte portion P12 with respect to the active material P10 and the first electrolyte portion P11 can be made more excellent.

The lithium composite metal oxide represented by Composition Formula (2) and constituting the second electrolyte portion P12 contains two or more elements selected from the group consisting of Nb, Ta, and Sb as the element M. When the element M constituting the lithium composite metal oxide contains at least Nb, when the lithium composite metal oxide is represented by the following composition formula (2′), a value of z′ is preferably 0.01 or more and 0.40 or less, and more preferably 0.05 or more and 0.38 or less.

Li_{7-z}La₃(Zr_{2-z}Nb_{z}′M′_{z}″)O₁₂ (2′)

(In Formula (2′), an element M′ is one or more types of elements selected from the group consisting of Ta and Sb, 0.00<z′, 0.00<z″, and 0.00<z′+z″<2.00.)

Accordingly, the crystallinity of the second electrolyte portion decreases, a smooth interface is formed, and the conductivity of lithium ions is further improved.

The second solid electrolyte constituting the second electrolyte portion P12 may contain another element, that is, elements other than Li, La, Zr, Nb, Ta, Sb and O by only a minute amount, in addition to the elements constituting Composition Formula (2). The another element may be one type or two or more types.

A content of the another element contained in the second solid electrolyte is preferably 100 ppm or less, and more preferably 50 ppm or less.

When two or more elements are contained as the another element, a sum of contents of the elements is adopted as the content of the another element.

It is sufficient that the second electrolyte portion P12 contains the second solid electrolyte, and may further contain a component other than the second solid electrolyte.

A content of the component other than the second solid electrolyte in the second electrolyte portion P12 is preferably 5.0 mass % or less, more preferably 3.0 mass % or less, and still more preferably 1.0 mass % or less.

A proportion of the second electrolyte portion P12 in the composite P100 is preferably 0.06 mass% or more and 19.0 mass % or less, more preferably 0.09 mass % or more and 9.3 mass % or less, and still more preferably 0.12 mass % or more and 4.8 mass % or less.

Accordingly, a battery having a better C rate (charging and discharging speed) can be obtained.

When the second electrolyte portion P12 is formed in a film shape at the surface of the active material P10, an average thickness of the second electrolyte portion P12 is preferably 0.002 μm or more and 0.300 μm or less, more preferably 0.003 μm or more and 0.150 μm or less, and still more preferably 0.004 μm or more and 0.080 μm or less.

Accordingly, a battery having a better C rate (charging and discharging speed) can be obtained.

In the present specification, the average thickness of the second electrolyte portion P12 refers to a thickness of the second electrolyte portion P12 obtained by calculation based on a mass of the active materials P10 and the second electrolyte portions P12 contained in the entire composite P100, assuming that the second electrolyte portion P12 is provided with a uniform thickness at the entire outer surface of the active material P10. In particular, when the active material P10 has a particle shape, the average thickness of the second electrolyte portion P12 refers to a thickness of the second electrolyte portion P12 obtained when is calculated based on a specific gravity based on the mass of the active materials P10 and the second electrolyte portions P12 provided in the entire composite P100 when it is assumed that each active material P10 has a true spherical shape having the same diameter as the average particle diameter and the second electrolyte portion P12 having a uniform thickness is formed at the entire outer surface of each active material P10.

When the active material P10 has a particle shape, when the average particle diameter of the active material P10 is D [μm] and the average thickness of the second electrolyte portion P12 is T [μm], preferably 0.0005≤T/D≤0.2500, more preferably 0.0005≤T/D≤0.0700, and still more preferably 0.0010≤T/D≤0.0200.

Accordingly, a battery having a better C rate (charging and discharging speed) can be obtained.

It is sufficient that the second electrolyte portion P12 covers at least a part of the surface of the active material P10. A coverage ratio of the second electrolyte portion P12 with respect to the outer surface of the active material P10, that is, a proportion of an area of a covering portion of the second electrolyte portion P12 with respect to a total area of the outer surface of the active material P10 is not particularly limited, but preferably 30% or more, more preferably 40% or more, and still more preferably 50% or more. Further, an upper limit of the coverage ratio may be 100% or less than 100%.

Accordingly, the above-described effects are remarkably exerted.

### 1-4 Third Electrolyte Portion

It is sufficient that the composite according to the present disclosure includes the above-described configuration, that is, the active materials, the first electrolyte portions, and the second electrolyte portions, and the composite further contains amorphous third electrolyte portions P13 in contact with the first electrolyte portions P11 and containing Li in the shown configuration in addition to the active materials P10, the first electrolyte portions P11, and the second electrolyte portions P12. In particular, the third electrolyte portion P13 is provided in a space inside the composite P100.

Accordingly, a proportion of voids in the composite P100 can be further reduced, and the above-described effects according to the present disclosure are remarkably exerted.

In the following description, an amorphous solid electrolyte constituting the third electrolyte portion P13 is also referred to as a “third solid electrolyte”.

It is sufficient that the third electrolyte portion P13 includes an amorphous electrolyte containing Li, that is, the third solid electrolyte. Examples of the third solid electrolyte include Li₃BO₃, Li₃BO₃—Li₄SiO₄, Li₃BO₃—Li₃PO₄, Li₃BO₃—Li₂SO₄, Li₂CO₃—Li₃BO₃, Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMOO₄, Li₄SiO₄—Li₄ZrO₄, SiO₂—P₂O₅—Li₂O, SiO₂—P₂O₅—LiCl, Li₂O—LiCl—B₂O₃, LiI, LiI—CaI₂, LiI—Cao, LiAlCl₄, LiAlF₄, LiF—Al₂O₃, LiBr—Al₂O₃, LiI—Al₂O₃, Li_{2.88}PO_{3.73}N_{0.14}, Li₃NI₂, Li₃N—LiI—LiOH, Li₃N—LiCl, Li₆NBr₃, Li₂S—SiS₂, Li₂S—SiS₂—LiI, and Li₂S—SiS₂—P₂S₅, and one type or a combination of two or more types selected from these examples can be used.

In particular, the third electrolyte portion P13 preferably contains Li, B, and O.

Accordingly, the lithium-ion conductivity of the composite P100 can be further improved. Further, such a third solid electrolyte generally has a low melting point, and for example, voids inside a molded article including the active materials P10, the first electrolyte portions P11, and the second electrolyte portions P12 can be suitably filled with a molten liquid of the third solid electrolyte by a method to be described below.

It is sufficient that the third electrolyte portion P13 is in contact with the first electrolyte portion P11 and contains the third solid electrolyte, and may contain a component other than the third solid electrolyte.

A content of the component other than the third solid electrolyte in the third electrolyte portion P13 is preferably 5.0 mass % or less, more preferably 3.0 mass % or less, and still more preferably 1.0 mass % or less.

A proportion of the third electrolyte portion P13 in the composite P100 is preferably 1 mass% or more and 10 mass % or less, more preferably 1 mass % or more and 8 mass % or less, and still more preferably 1 mass % or more and 6 mass % or less.

Accordingly, a battery having a particularly excellent balance between the battery capacity and the C rate (charging and discharging speed) can be obtained.

### 1-5 Another Configuration

The composite P100 may include a configuration other than the above-described active material P10, first electrolyte portion P11, second electrolyte portion P12, and third electrolyte portion P13. Hereinafter, such a configuration is also referred to as “another configuration” in this item.

Examples of the another configuration include a fourth electrolyte portion containing a crystalline solid electrolyte represented by a composition formula other than Composition Formula (1) and Composition Formula (2).

A proportion of the another configuration in the composite P100 is preferably 5.0 mass % or less, more preferably 3.0 mass % or less, and still more preferably 1.0 mass % or less.

### 1-6 Another Condition

A size and a shape of the composite P100 are not particularly limited.

In the shown configuration, a boundary between the active material P10 and the second electrolyte portion P12, a boundary between the second electrolyte portion P12 and the first electrolyte portion P11, and a boundary between the first electrolyte portion P11 and the third electrolyte portion P13 are clear. However, the boundary portions may not necessarily be clear, and an adjacent part, for example, a part of a constituent component of one of the active material P10 and the second electrolyte portion P12 may be transferred to the other of the active material P10 and the second electrolyte portion P12.

In the shown configuration, the third electrolyte portion P13 is in contact with only the first electrolyte portion P11, and may be in contact with a portion other than the first electrolyte portion P11 together with the first electrolyte portion P11, such as the active material P10 or the second electrolyte portion P12.

In the shown configuration, the second electrolyte portion P12 is in contact with only the active material P10 and the first electrolyte portion P11, and may be in contact with a portion other than the active material P10 and the first electrolyte portion P11 together with the first electrolyte portion P11, such as the third electrolyte portion P13.

In the shown configuration, the first electrolyte portion P11 is in contact with only the second electrolyte portion P12 and the third electrolyte portion P13, and may be in contact with a portion other than the second electrolyte portion P12 and the third electrolyte portion P13 together with the second electrolyte portion P12 and the third electrolyte portion P13, such as the active material P10.

### 2 Method of Manufacturing Composite

Next, a method for manufacturing the composite according to the present disclosure will be described.

For example, the composite according to the present disclosure can be suitably manufactured by using a method including a second precursor contact step of bringing a solution containing a precursor of the second solid electrolyte into contact with the active material P10, a first precursor contact step of bringing a solution containing a precursor of the first solid electrolyte into contact with the active material P10 which is subjected to the second precursor contact step, and a third electrolyte portion formation step of forming the third electrolyte portion P13 by bringing the active material P10 which is subjected to the second precursor contact step and the first precursor contact step into contact with the third solid electrolyte.

### 2-1 Second Precursor Contact Step

In the second precursor contact step, the solution containing the precursor of the second solid electrolyte is brought into contact with the active material P10.

A method of bringing the solution containing the precursor of the second solid electrolyte into contact with the active material P10 is not particularly limited, and examples thereof include a method of adding the active material P10 to the solution containing the precursor of the second solid electrolyte and a method of applying the solution containing the precursor of the second solid electrolyte to the active material P10.

Examples of the method of adding the active material P10 to the solution containing the precursor of the second solid electrolyte include a dipping method.

Examples of the method of applying the solution containing the precursor of the second solid electrolyte to the active material P10 include a dropping method, a spraying method, a coating method, and a spin coating method.

Examples of the solution containing the precursor of the second solid electrolyte include a solution in which a lithium compound, a lanthanum compound, a zirconium compound, and a metal compound containing the element M are dissolved.

Such a solution can be prepared by mixing, for example, a lithium raw material solution in which the lithium compound is dissolved, a lanthanum raw material solution in which the lanthanum compound is dissolved, a zirconium raw material solution in which the zirconium compound is dissolved, and a metal raw material solution in which the metal compound containing the element M is dissolved. In this case, an order of mixing the raw material solutions is not particularly limited.

As described above, when the raw material solutions are used, solvents and dispersion mediums constituting the raw material solutions may have a common composition or different compositions.

In a preparation of the solution containing the precursor of the second solid electrolyte, it is preferable to use the lithium compound such that a content of lithium in the solution is one times or more and 1.2 times or less of the stoichiometric composition in Composition Formula (2).

In the preparation of the solution containing the precursor of the second solid electrolyte, it is preferable to use the lanthanum compound such that a content of lanthanum in the solution is equal to the stoichiometric composition in Composition Formula (2).

In the preparation of the solution containing the precursor of the second solid electrolyte, it is preferable to use the zirconium compound such that a content of zirconium in the solution is equal to the stoichiometric composition in Composition Formula (2).

In the preparation of the solution containing the precursor of the second solid electrolyte, it is preferable to use the metal compound containing the element M such that a content of the element M in the solution is equal to the stoichiometric composition in Composition Formula (2).

Examples of the lithium compound include a lithium metal salt and a lithium alkoxide, and one type or a combination of two or more types selected from these can be used. Examples of the lithium metal salt include a lithium chloride, a lithium nitrate, a lithium sulfate, a lithium acetate, a lithium hydroxide, a lithium carbonate, and a (2,4-pentanedionato) lithium. Examples of the lithium alkoxide include a lithium methoxide, a lithium ethoxide, a lithium-n-propoxide, a lithium isopropoxide, a lithium-n-butoxide, a lithium isobutoxide, a lithium secondary butoxide, a lithium tertiary butoxide, and a dipivaloylmethanate lithium. Among these, as the lithium compound, one type or two or more types selected from the group consisting of lithium nitrate, lithium sulfate, and (2,4-pentanedionato) lithium are preferred. As a lithium source, a hydrate may be used.

Examples of a lanthanum compound, which is a metal compound, as the lanthanum source include a lanthanum metal salt and a lanthanum alkoxide, and one type or a combination of two or more types selected from these can be used. Examples of the lanthanum metal salt include a lanthanum chloride, a lanthanum nitrate, a lanthanum sulfate, a lanthanum acetate, and a tris (2,4-pentanedionato) lanthanum. Examples of the lanthanum alkoxide include a lanthanum trimethoxide, a lanthanum triethoxide, a lanthanum-tri-n-propoxide, a lanthanum triisopropoxide, a lanthanum-tri-n-butoxide, a lanthanum triisobutoxide, a lanthanum trisecondary butoxide, a lanthanum tritertiary butoxide, and a tris (dipivaloylmethanate) lanthanum. Among these, as the lanthanum compound, at least one of lanthanum nitrate and tris (2,4-pentanedionato) lanthanum is preferred. As a lanthanum source, a hydrate may be used.

Examples of a zirconium compound, which is a metal compound, as a zirconium source, include a zirconium metal salt and a zirconium alkoxide, and one type or a combination of two or more types selected from these can be used. Examples of the zirconium metal salt include a zirconium chloride, a zirconium oxychloride, a zirconium oxynitrate, a zirconium oxysulfate, a zirconium oxyacetate, and a zirconium acetate. Examples of the zirconium alkoxide include a zirconium tetramethoxide, a zirconium tetraethoxide, a zirconium tetra-n-propoxide, a zirconium tetraisopropoxide, a zirconium tetra-n-butoxide, a zirconium tetraisobutoxide, a zirconium tetrasecondary butoxide, a zirconium tetratertiary butoxide, and a tetrakis (dipivaloylmethanate) zirconium. Among these, as the zirconium compound, zirconium tetra-n-butoxide is preferred. As a zirconium source, a hydrate may be used.

Examples of a tantalum compound, which is a metal compound, as a tantalum source of the element M include a tantalum metal salt and a tantalum alkoxide, and one type or a combination of two or more types selected from these can be used. Examples of the tantalum metal salt include a tantalum chloride and a tantalum bromide. Examples of the tantalum alkoxide include a tantalum pentamethoxide, a tantalum pentaethoxide, a tantalum pentaisopropoxide, a tantalum penta-n-propoxide, a tantalum pentaisobutoxide, a tantalum penta-n-butoxide, a tantalum pentasecondary butoxide, and a tantalum pentatertiary butoxide. Among these, as the tantalum compound, one type or two or more types selected from the group consisting of tantalum pentaethoxide, tantalum penta-n-propoxide, and tantalum penta-n-butoxide are preferred. As a tantalum source, a hydrate may be used.

Examples of an antimony compound, which is a metal compound, as an antimony source of the element M include an antimony metal salt and an antimony alkoxide, and one type or a combination of two or more types selected from these can be used. Examples of the antimony metal salt include an antimony bromide, an antimony chloride, and an antimony fluoride. Examples of the antimony alkoxide include an antimony trimethoxide, an antimony triethoxide, an antimony triisopropoxide, an antimony tri-n-propoxide, an antimony triisobutoxide, and an antimony tri-n-butoxide. Among these, as the antimony compound, at least one of antimony triisobutoxide and antimony tri-n-butoxide is preferred. As an antimony source, a hydrate may be used.

Examples of a niobium compound, which is a metal compound, as a niobium source of the element M include a niobium metal salt, a niobium alkoxide, and a niobium acetyl acetone, and one type or a combination of two or more types selected from these can be used. Examples of the niobium metal salt include a niobium chloride, a niobium oxychloride, and a niobium oxalate. Examples of the niobium alkoxide include a niobium pentaethoxide, a niobium penta-n-propoxide, a niobium penta-n-butoxide, a niobium pentaisopropoxide, and a niobium pentasecondary butoxide. Among these, as the niobium compound, niobium penta-n-butoxide is preferred. As a niobium source, a hydrate may be used.

The solution containing the precursor of the second solid electrolyte preferably contains an oxo anion.

Accordingly, the second solid electrolyte can be suitably formed by a subsequent heat treatment, in particular, a heat treatment under a relatively mild condition. The second electrolyte portion P12 formed of the second solid electrolyte formed in this way has excellent adhesion to the active material P10 and the first electrolyte portion P11 formed of the first solid electrolyte. As a result, the reliability of the finally obtained composite P100 can be made more excellent.

In the present step, when the solution containing the precursor of the second solid electrolyte is prepared to contain an oxo anion, it is preferable to use a metal salt containing an oxo anion as the various metal compounds as raw materials for forming the above-described second solid electrolyte, and in the preparation of the solution containing the precursor of the second solid electrolyte, an oxo acid compound containing no metal element and containing an oxo anion may be further used as a component different from the various metal compounds.

Examples of the oxo anion include a halogen oxo acid ion, a borate ion, a carbonate ion, an ortho carbonate ion, a carboxylate ion, a silicate ion, a nitrite ion, a nitrate ion, a phosphorous acid ion, a phosphate ion, an arsenic acid ion, a sulfurous acid ion, a sulfate ion, a sulfonate ion, and a sulfinic ion. Examples of the halogen oxoacid ion include a hypochlorite ion, a chlorite ion, a chlorate ion, a perchlorate ion, a hypobromite ion, a bromite ion, a bromate ion, a perbromate ion, a hypoiodite ion, an iodite ion, an iodate ion, and a periodate ion.

The oxo acid compound may be added, for example, at a timing during a heat treatment to be described later or during the heat treatment after the present step.

In the second precursor contact step, the active material P10 to be brought into contact with the solution containing the precursor of the second solid electrolyte may satisfy the same condition as that of the active material P10 constituting the composite P100, or may satisfy different conditions. More specifically, for example, in the second precursor contact step, the active material P10 to be brought into contact with the solution containing the precursor of the second solid electrolyte may have different conditions such as shape and size from the active material P10 constituting the composite P100.

The solvent or the dispersion medium is not particularly limited, and for example, water and various organic solvents can be used. Examples of the organic solvent include alcohols, glycols, ketones, esters, ethers, organic acids, aromatics, and amides, and one type or a mixed solvent that is a combination of two or more types selected from these can be used. Examples of the alcohols include methyl alcohol, ethyl alcohol, n-propyl alcohol, isopropyl alcohol, n-butyl alcohol, 2-propene-1-ol, and 2-n-butoxyethanol. Examples of the glycols include ethylene glycol, propylene glycol, butylene glycol, hexylene glycol, pentanediol, hexanediol, heptanediol, and dipropylene glycol. Examples of the ketones include dimethyl ketone, methyl ethyl ketone, methyl propyl ketone, and methyl isobutyl ketone. Examples of the esters include methyl formate, ethyl formate, methyl acetate, and methyl acetoacetate. Examples of the ethers include diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acids include formic acid, acetic acid, 2-ethylbutyric acid, and propionic acid. Examples of the aromatics include toluene, o-xylene, and p-xylene. Examples of the amides include formamide, N, N-dimethylformamide, N, N-diethylformamide, dimethylacetamide, and N-methylpyrrolidone. Among these, as the solvent or the dispersion medium, at least one of 2-n-butoxyethanol and propionic acid is preferred.

### 2-2 First Heating Treatment Step

In the embodiment, before the first precursor contact step to be described later, the active material P10 subjected to the above-described second precursor contact step, that is, the active material P10 to which the precursor of the second solid electrolyte adheres is heated.

Accordingly, for example, the solvent or the dispersion medium contained in the solution containing the precursor of the second solid electrolyte can be suitably removed, and at least a part of the precursor of the second solid electrolyte can be converted into a metal oxide such as the second solid electrolyte. In particular, when the solution containing the precursor of the second solid electrolyte contains an oxo anion, an oxide different from the second solid electrolyte can be suitably formed in the present step. Hereinafter, the oxide is also referred to as a “second precursor oxide”. As a result, for example, the precursor of the second solid electrolyte and the second solid electrolyte which adhere to the active material P10 are effectively prevented from being unintentionally peeled off in subsequent steps. In addition, the adhesion of the second electrolyte portion P12 formed of the second solid electrolyte to the active material P10 and the first electrolyte portion P11 formed of the first solid electrolyte in the composite P100 can be made more excellent. As a result, the reliability of the finally obtained composite P100 can be made more excellent.

In the following description, the solution containing the precursor of the second solid electrolyte contains an oxo anion, and a case in which the second precursor oxide is formed in the present step will be mainly described.

The heating in the present step is preferably performed under such a condition that a content of a liquid component contained in the solution containing the precursor of the second solid electrolyte is sufficiently low.

More specifically, the content of the liquid component contained in a solid composition obtained in the present step, that is, the content of the above-described solvent and dispersion medium is preferably 1.0 mass % or less, and more preferably 0.1 mass % or less.

The heat treatment in the present step may be performed under constant conditions or may be performed under different conditions in combination.

For example, a heat treatment A aiming at removing the above-described solvent and dispersion medium and a heat treatment B aiming at reacting the precursor of the second solid electrolyte, that is, the above-described lithium compound, lanthanum compound, zirconium compound, and metal compound containing the element M may be performed in combination.

In this case, for example, a portion corresponding to the solution containing the precursor of the second solid electrolyte applied in the second precursor contact step can be formed of a gelled composition by the heat treatment A, and a state can be made to contain almost no liquid component as described above by the subsequent heat treatment B. In particular, when the solution containing the precursor of the second solid electrolyte contains an oxo anion, the second precursor oxide can be efficiently formed by the heat treatment B.

Although conditions for the heat treatment A depend on a boiling point of the solvent or the dispersion medium and a vapor pressure, a heating temperature in the heat treatment A is preferably 50° C. or higher and 250° C. or lower, more preferably 60° C. or higher and 230° C. or lower, and still more preferably 80° C. or higher and 200° C. or lower.

Further, a heating time in the heat treatment A is preferably 10 minutes or more and 180 minutes or less, more preferably 20 minutes or more and 120 minutes or less, and still more preferably 30 minutes or more and 60 minutes or less.

The heat treatment A may be performed in any atmosphere, may be performed in an oxidizing atmosphere such as air or an oxygen gas atmosphere, or may be performed in a non-oxidizing atmosphere such as an inert gas such as a nitrogen gas, a helium gas, or an argon gas. The heat treatment A may be performed under reduced pressure or vacuum, or may be performed under pressurization.

In the heat treatment A, the atmosphere may be maintained under substantially the same conditions, or may be changed to different conditions.

Although conditions for the heat treatment B depend on the composition of the second precursor oxide to be formed, a heating temperature in the heat treatment B is preferably 400° C. or higher and 600° C. or lower, more preferably 430° C. or higher and 600° C. or lower, and still more preferably 450° C. or higher and 600° C. or lower.

Further, a heating time in the heat treatment B is preferably 5 minutes or more and 180 minutes or less, more preferably 10 minutes or more and 120 minutes or less, and still more preferably 15 minutes or more and 120 minutes or less.

The heat treatment B may be performed in any atmosphere, may be performed in an oxidizing atmosphere such as air or an oxygen gas atmosphere, or may be performed in a non-oxidizing atmosphere such as an inert gas such as a nitrogen gas, a helium gas, or an argon gas. The heat treatment B may be performed under reduced pressure or vacuum, or may be performed under pressurization. In particular, the heat treatment B is preferably performed in an oxidizing atmosphere.

The heat treatment A and the heat treatment B may be continuously performed, and in the heat treatment A, for example, the temperature may be raised at a constant rising speed without providing a time for maintaining the temperature in a predetermined range.

When the solid composition obtained in the present step contains the second precursor oxide, the second precursor oxide preferably has a crystal structure different from a crystal structure of the second solid electrolyte. In the present disclosure, the “different” in terms of crystal structure is a broad concept not only including that the type of crystal structure is not the same, but also including that even when the type is the same, at least one lattice constant is different, or the like.

In particular, the second solid electrolyte is formed of a solid electrolyte having a cubic crystal garnet type crystal structure, whereas the crystal structure of the second precursor oxide is preferably a tetragonal crystal garnet type crystal structure or a pyrochlore oxide structure.

Accordingly, even when the conditions of the heating treatment after the present step are relaxed, for example, even when the temperature is set to lower or the time is set to be shorter, it is possible to suitably form the second electrolyte portion P12 formed of the solid electrolyte that is excellent in adhesion to the active material P10 and the first electrolyte portion P11 and particularly excellent in characteristics such as ion conductivity.

The crystal structure of the second precursor oxide may be a crystal structure other than the tetragonal crystal garnet type crystal structure and the pyrochlore oxide structure, for example, a cubic crystal such as a perovskite structure, a rock salt type structure, a diamond structure, a formation type structure, or a spinel type structure, an oblique crystal such as a ramsdellite type, or a trigonal type such as a corundum type.

The crystal grain diameter of the second precursor oxide is not particularly limited, but is preferably 10 nm or more and 200 nm or less, more preferably 15 nm or more and 180 nm or less, and still more preferably 20 nm or more and 160 nm or less.

Accordingly, the melting temperature of the second precursor oxide can be further lowered by the so-called Gibbs-Thomson effect, which is a melting point lowering phenomenon caused by an increase in surface energy, and the conditions of the heating treatment after the present step can be further relaxed. In addition, in the finally obtained composite P100, adhesion between the active material P10 and the second electrolyte portion P12 and adhesion between the second electrolyte portion P12 and the first electrolyte portion P11 can be made more excellent.

The second precursor oxide is preferably implemented by a substantially single crystal structure.

Accordingly, in the heating treatment after the present step, a crystal phase transition that occurs when forming the solid electrolyte having the cubic crystal garnet type crystal structure occurs substantially once, and therefore, segregation of elements accompanying the crystal phase transition and generation of contaminant crystals due to thermal decomposition are prevented, and various characteristics of the second solid electrolyte are further improved.

When only one exothermic peak is observed within a range of 300° C. or higher and 1000° C. or lower when measurement is performed by TG-DTA at a temperature raising rate of 10° C./min for a target object, it can be determined that the target object“is implemented by a substantially single crystal structure”.

### 2-3 First Precursor Contact Step

In the first precursor contact step, the solution containing the precursor of the first solid electrolyte is brought into contact with the active material P10 subjected to the second precursor contact step.

A method of bringing the solution containing the precursor of the first solid electrolyte into contact with the active material P10 subjected to the second precursor contact step is not particularly limited, and examples thereof include a method of adding the active material P10 subjected to the second precursor contact step to the solution containing the precursor of the first solid electrolyte and a method of applying the solution containing the precursor of the first solid electrolyte to the active material P10 subjected to the second precursor contact step.

Examples of the method of adding the active material P10 subjected to the second precursor contact step to the solution containing the precursor of the first solid electrolyte include a dipping method.

Examples of the method of applying the solution containing the precursor of the first solid electrolyte to the active material P10 subjected to the second precursor contact step include a dropping method, a spraying method, a coating method, and a spin coating method.

Examples of the solution containing the precursor of the first solid electrolyte include a solution in which a lithium compound, a gallium compound, a lanthanum compound, a calcium compound, and a zirconium compound are dissolved.

Such a solution can be prepared by mixing, for example, a lithium raw material solution in which the lithium compound is dissolved, a gallium raw material solution in which the gallium compound is dissolved, a lanthanum raw material solution in which the lanthanum compound is dissolved, a calcium raw material solution in which the calcium compound is dissolved, and a zirconium raw material solution in which the zirconium compound is dissolved. In this case, an order of mixing the raw material solutions is not particularly limited.

As described above, when the raw material solutions are used, solvents and dispersion mediums constituting the raw material solutions may have a common composition or different compositions.

In a preparation of the solution containing the precursor of the first solid electrolyte, it is preferable to use the lithium compound such that a content of lithium in the solution is 1.05 times or more and 1.30 times or less of the stoichiometric composition in Composition Formula (1).

In the preparation of the solution containing the precursor of the first solid electrolyte, it is preferable to use the gallium compound such that a content of gallium in the solution is equal to the stoichiometric composition in Composition Formula (1).

In the preparation of the solution containing the precursor of the first solid electrolyte, it is preferable to use the lanthanum compound such that a content of lanthanum in the solution is equal to the stoichiometric composition in Composition Formula (1).

In the preparation of the solution containing the precursor of the first solid electrolyte, it is preferable to use the calcium compound such that a content of calcium in the solution is equal to the stoichiometric composition in Composition Formula (1).

In the preparation of the solution containing the precursor of the first solid electrolyte, it is preferable to use the zirconium compound such that a content of zirconium in the solution is equal to the stoichiometric composition in Composition Formula (1).

As a lithium source, a lanthanum source, and a zirconium source contained in the solution containing the precursor of the first solid electrolyte, for example, the lithium compound, the lanthanum compound, and the zirconium compound described as the components contained in the solution containing the precursor of the second solid electrolyte in 2-1 can be used, and the conditions are preferably similar to those described in 2-1.

Examples of the gallium compound, which is a metal compound, as the gallium source, include a gallium metal salt and a gallium alkoxide, and one type or a combination of two or more types selected from these can be used. Examples of the gallium metal salt include a gallium bromide, a gallium chloride, a gallium iodide, and a gallium nitrate. Examples of the gallium alkoxide include a gallium trimethoxide, a gallium triethoxide, a gallium tri-n-propoxide, a gallium triisopropoxide, and a gallium tri-n-butoxide. Among these, as the gallium compound, gallium nitrate is preferred. As the gallium source, a hydrate may be used.

Examples of the calcium compound, which is a metal compound, as the calcium source, include a calcium metal salt and a calcium alkoxide, and one type or a combination of two or more types selected from these can be used. Examples of the calcium metal salt include a calcium bromide, a calcium chloride, a calcium fluoride, a calcium iodide, a calcium sucrose, a calcium acetate, and a calcium nitrate. Examples of the calcium alkoxide include a calcium methoxide, a calcium diethoxide, a calcium diisopropoxide, a calcium di-n-propoxide, calcium diisobutoxide, calcium di-n-butoxide, and calcium disecondary butoxide. Among these, as the calcium compound, calcium nitrate is preferred. As the calcium source, a hydrate may be used.

The solution containing the precursor of the first solid electrolyte preferably contains an oxo anion.

Accordingly, the first solid electrolyte can be suitably formed by a subsequent heat treatment, in particular, a heat treatment under a relatively mild condition. The first electrolyte portion P11 formed of the first solid electrolyte formed in this way has excellent adhesion to the second electrolyte portion P12 formed of the second solid electrolyte. As a result, the reliability of the finally obtained composite P100 can be made more excellent.

In the present step, when the solution containing the precursor of the first solid electrolyte is prepared to contain an oxo anion, it is preferable to use a metal salt containing an oxo anion as the various metal compounds as raw materials for forming the above-described first solid electrolyte, and in the preparation of the solution containing the precursor of the first solid electrolyte, an oxo acid compound containing no metal element and containing an oxo anion may be further used as a component different from the various metal compounds.

Examples of the oxo anion include those described in 2-1.

The oxo acid compound may be added, for example, at a timing during a heat treatment to be described later or during the heat treatment after the present step.

The solvent or the dispersion medium constituting the solution containing the precursor of the first solid electrolyte is not particularly limited, and examples thereof include those described in 2-1. Among these, as the solvent or the dispersion medium, at least one of 2-n-butoxyethanol and propionic acid is preferred.

### 2-4 Second Heating Treatment Step

In the embodiment, before the third electrolyte portion formation step to be described later, the active material P10 subjected to the above-described first precursor contact step, that is, the active material P10 to which the second precursor oxide and the precursor of the first solid electrolyte adhere is heated.

Accordingly, for example, the solvent or the dispersion medium contained in the solution containing the precursor of the first solid electrolyte can be suitably removed, and at least a part of the precursor of the first solid electrolyte can be converted into a metal oxide such as the first solid electrolyte. In particular, when the solution containing the precursor of the first solid electrolyte contains an oxo anion, an oxide different from the first solid electrolyte can be suitably formed in the present step. Hereinafter, the oxide is also referred to as a “first precursor oxide”. As a result, for example, the second precursor oxide on the active material P10, the precursor of the first solid electrolyte which adheres to the second solid electrolyte, and the first solid electrolyte are prevented from being unintentionally peeled off in the subsequent steps. In addition, the adhesion of the first electrolyte portion P11 formed of the first solid electrolyte to the second electrolyte portion P12 and the third electrolyte portion P13 in the composite P100 can be made more excellent. As a result, the reliability of the finally obtained composite P100 can be made more excellent.

In the following description, the solution containing the precursor of the first solid electrolyte contains an oxo anion, and a case in which the first precursor oxide is formed in the present step will be mainly described.

The heating in the present step is preferably performed under such a condition that a content of a liquid component contained in the solution containing the precursor of the first solid electrolyte is sufficiently low.

More specifically, the content of the liquid component contained in a solid composition obtained in the present step, that is, the content of the above-described solvent and dispersion medium is preferably 1.0 mass % or less, and more preferably 0.1 mass % or less.

The heat treatment in the present step may be performed under constant conditions or may be performed under different conditions in combination.

For example, the heat treatment A aiming at removing the above-described solvent and dispersion medium and the heat treatment B aiming at reacting the precursor of the first solid electrolyte, that is, the above-described lithium compound, gallium compound, lanthanum compound, calcium compound, and zirconium compound may be performed in combination.

In this case, for example, a portion corresponding to the solution containing the precursor of the first solid electrolyte applied in the first precursor contact step can be formed of a gelled composition by the heat treatment A, and a state can be made to contain almost no liquid component by the subsequent heat treatment B. In particular, when the solution containing the precursor of the first solid electrolyte contains an oxo anion, the first precursor oxide can be efficiently formed by the heat treatment B.

Although conditions for the heat treatment A depend on a boiling point of the solvent or the dispersion medium and a vapor pressure, a heating temperature in the heat treatment A is preferably 50° C. or higher and 250° C. or lower, more preferably 60° C. or higher and 230° C. or lower, and still more preferably 80° C. or higher and 200° C. or lower.

Further, a heating time in the heat treatment A is preferably 10 minutes or more and 180 minutes or less, more preferably 20 minutes or more and 120 minutes or less, and still more preferably 30 minutes or more and 60 minutes or less.

The heat treatment A may be performed in any atmosphere, may be performed in an oxidizing atmosphere such as air or an oxygen gas atmosphere, or may be performed in a non-oxidizing atmosphere such as an inert gas such as a nitrogen gas, a helium gas, or an argon gas. The heat treatment A may be performed under reduced pressure or vacuum, or may be performed under pressurization.

In the heat treatment A, the atmosphere may be maintained under substantially the same conditions, or may be changed to different conditions.

Although conditions for the heat treatment B depend on the composition of the first precursor oxide to be formed, a heating temperature in the heat treatment B is preferably 400° C. or higher and 600° C. or lower, more preferably 430° C. or higher and 600° C. or lower, and still more preferably 450° C. or higher and 600° C. or lower.

Further, a heating time in the heat treatment B is preferably 5 minutes or more and 180 minutes or less, more preferably 10 minutes or more and 120 minutes or less, and still more preferably 15 minutes or more and 120 minutes or less.

The heat treatment B may be performed in any atmosphere, may be performed in an oxidizing atmosphere such as air or an oxygen gas atmosphere, or may be performed in a non-oxidizing atmosphere such as an inert gas such as a nitrogen gas, a helium gas, or an argon gas. The heat treatment B may be performed under reduced pressure or vacuum, or may be performed under pressurization. In particular, the heat treatment B is preferably performed in an oxidizing atmosphere.

The heat treatment A and the heat treatment B may be continuously performed, and in the heat treatment A, for example, the temperature may be raised at a constant rising speed without providing a time for maintaining the temperature in a predetermined range.

When the solid composition obtained in the present step contains the first precursor oxide, the first precursor oxide preferably has a crystal structure different from a crystal structure of the first solid electrolyte. In the present disclosure, the “different” in terms of crystal structure is a broad concept not only including that the type of crystal structure is not the same, but also including that even when the type is the same, at least one lattice constant is different, or the like.

In particular, the first solid electrolyte is formed of a solid electrolyte having a cubic crystal garnet type crystal structure, whereas the crystal structure of the first precursor oxide is preferably a tetragonal crystal garnet type crystal structure or a pyrochlore oxide structure.

Accordingly, even when the conditions of the heating treatment after the present step are relaxed, for example, even when the temperature is set to lower or the time is set to be shorter, it is possible to suitably form the first electrolyte portion P11 formed of the solid electrolyte that is excellent in adhesion to the second electrolyte portion P12 and the third electrolyte portion P13 and particularly excellent in characteristics such as ion conductivity.

The crystal structure of the first precursor oxide may be a crystal structure other than the tetragonal crystal garnet type crystal structure and the pyrochlore oxide structure, for example, a cubic crystal such as a perovskite structure, a rock salt type structure, a diamond structure, a fluorite type structure, and a spinel type structure, an orthorhombic crystal such as a ramsdellite type, or a trigonal crystal such as a corundum type.

A crystal grain diameter of the first precursor oxide is not particularly limited, but is preferably 10 nm or more and 200 nm or less, more preferably 15 nm or more and 180 nm or less, and still more preferably 20 nm or more and 160 nm or less.

Accordingly, due to a so-called Gibbs-Thomson effect which is a phenomenon of lowering the melting point with an increase in surface energy, a melting temperature of the first precursor oxide can be further lowered, and the conditions of the heating treatment after the present step can be further relaxed. In addition, in the finally obtained composite P100, the adhesion between the second electrolyte portion P12 and the first electrolyte portion P11 and the adhesion between the first electrolyte portion P11 and the third electrolyte portion P13 can be made more excellent.

The first precursor oxide is preferably implemented by a substantially single crystal structure.

Accordingly, in the heating treatment after the present step, a crystal phase transition that occurs when forming the solid electrolyte having the cubic crystal garnet type crystal structure occurs substantially once, and therefore, segregation of elements accompanying the crystal phase transition and generation of contaminant crystals due to thermal decomposition are prevented, and various characteristics of the first solid electrolyte are further improved.

### 2-5 Third Heating Treatment Step

In the embodiment, before the third electrolyte portion formation step to be described later, the active material P10 subjected to the above-described first precursor contact step is heated. In particular, the active material P10 subjected to the first precursor contact step and the second heating treatment step is heated.

Accordingly, the second precursor oxide becomes the second solid electrolyte, and the second electrolyte portion P12 is formed. Meanwhile, the first precursor oxide becomes the first solid electrolyte, and the first electrolyte portion P11 is formed. Even when a raw material containing an oxo anion is used in the manufacturing of the composite P100, the oxo anion can be sufficiently removed in the present step, and the content of the oxo anion contained in the finally obtained composite P100 can be sufficiently low. As a result, the reliability of the composite P100 can be made more excellent.

In the present step, a heat treatment is usually performed at a temperature higher than that in the heat treatments in the above-described first heating treatment step and second heating treatment step.

A heating temperature in the present step is, for example, preferably 700° C. or higher and 1000° C. or lower, more preferably 730° C. or higher and 980° C. or lower, and still more preferably 750° C. or higher and 900° C. or lower.

Accordingly, the second solid electrolyte and the first solid electrolyte can be efficiently formed by the heat treatment at a relatively low temperature and a relatively short time, the adhesion between the active material P10 and the second electrolyte portion P12 and the adhesion between the second electrolyte portion P12 and the first electrolyte portion P11 can be made more excellent, and the lithium-ion conductivity of the composite P100 can be further improved.

In the third heating treatment step, the heating temperature may be changed. For example, the third heating treatment step may have a first stage in which the heat treatment is performed while maintaining a relatively low temperature and a second stage in which the heat treatment is performed at a relatively high temperature by raising the temperature after the first stage. In such a case, it is preferred that a highest temperature in the third heating treatment step falls within the above-described range.

The heating time in the third heating treatment step is not particularly limited, but is preferably 2 hours or more and 15 hours or less, more preferably 4 hours or more and 12 hours or less, and still more preferably 4 hours or more and 10 hours or less.

Accordingly, the above-described effects are remarkably exerted.

The third heating treatment step may be performed in any atmosphere, may be performed in an oxidizing atmosphere such as air or an oxygen gas atmosphere, or may be performed in a non-oxidizing atmosphere such as an inert gas such as a nitrogen gas, a helium gas, or an argon gas. Further, the third heating treatment step may be performed under reduced pressure or vacuum, or may be performed under pressurization.

In the third heating treatment step, the atmosphere may be maintained under substantially the same conditions, or may be changed to different conditions.

### 2-6 Third Electrolyte Portion Formation Step

In the third electrolyte portion formation step, the third electrolyte portion P13 is formed by bringing the active material P10 subjected to the second precursor contact step and the first precursor contact step into contact with the third solid electrolyte.

Accordingly, the composite P100 is obtained.

Examples of a method for forming the third electrolyte portion P13 include a method of supplying the molten liquid of the third solid electrolyte to the active material P10 subjected to the second precursor contact step and the first precursor contact step and a method of melting the third solid electrolyte in a state in which the molten liquid of the third solid electrolyte is brought into contact with the active material P10 subjected to the second precursor contact step and the first precursor contact step.

When the third electrolyte portion P13 is formed in the present step, the third solid electrolyte is usually heated to a temperature equal to or higher than a melting point thereof.

A heating temperature in the present step is different depending on the composition of the third solid electrolyte, and when the melting point of the third solid electrolyte is Tm [C], the heating temperature is preferably (Tm+5° C.) or higher and (Tm+150° C.) or lower, more preferably (Tm+10° C.) or higher and (Tm+100° C.) or lower, and still more preferably (Tm+15° C.) or higher and (Tm+80° C.) or lower.

Even when the composite P100 obtained as described above is manufactured by using a raw material containing an oxo anion, since the oxo anion is usually sufficiently removed in the third heating treatment step, the content of the oxo anion contained in the finally obtained composite P100 is sufficiently low. More specifically, the content of the oxo anion in the composite P100 is or less, in particular, preferably 50 ppm or less, and more preferably 10 ppm or less.

### 3 Battery

Next, a battery according to the present disclosure will be described.

The battery according to the present disclosure includes the above-described composite according to the present disclosure, an electrode provided at one surface side of the composite, and a current collector provided at the other surface side of the composite.

Accordingly, it is possible to provide a battery that includes a composite in which the adhesion between the solid electrolyte and the active material and the adhesion between the solid electrolytes are sufficiently excellent, an increase in grain-boundary resistance is prevented, and a decrease in lithium-ion conductivity is prevented, and whose discharging capacity is unlikely to decrease, and in particular, whose discharging capacity is suitably maintained even when charging and discharging are repeated.

Hereinafter, a specific configuration of a lithium-ion secondary battery as the battery according to the present disclosure will be described.

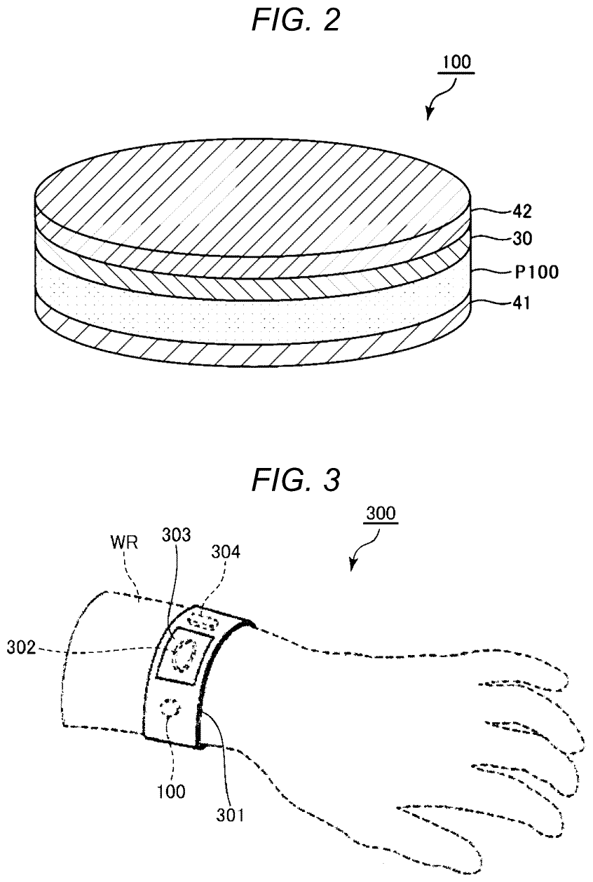

FIG. 2 is a schematic cross-sectional view schematically showing a structure of the lithium-ion secondary battery. In particular, FIG. 2 shows a coin type battery as an example of the lithium-ion secondary battery.

In particular, a lithium-ion battery 100 shown in FIG. 2 includes the above-described composite P100, a negative electrode 30 as the electrode provided in contact with one surface of the composite P100, and a current collector 41 provided in contact with an opposite surface of the surface in contact with the negative electrode 30 from the composite P100. The lithium-ion battery 100 shown in FIG. 2 further includes a current collector 42 provided in contact with an opposite surface of a surface in contact with the composite P100 from the negative electrode 30. That is, the lithium-ion battery 100 according to the embodiment has a configuration in which the current collector 41, the composite material P100, the negative electrode 30, and the current collector 42 are stacked in this order.

A shape of the lithium-ion battery 100 is not particularly limited, and may be, for example, a polygonal disk shape, but is a circular disk shape in the shown configuration. A size of the lithium-ion battery 100 is not particularly limited, but for example, a diameter of the lithium-ion battery 100 is, for example, 10 mm or more and 20 mm or less, and a thickness of the lithium-ion battery 100 is, for example, 0.1 mm or more and 1.0 mm or less.

When the lithium-ion battery 100 is small and thin as described above, the lithium-ion battery 100 can be a chargeable and dischargable all-solid body and can be suitably used as a power source for a mobile information terminal such as a smartphone. As will be described below, the lithium-ion battery 100 may be used for applications other than the power source for the mobile information terminal.

### 3-1 Composite

As described above, the composite P100 constituting the lithium-ion battery 100 includes the active materials P10, the first electrolyte portions P11, and the second electrolyte portions P12, at least a part of the first electrolyte portion P11 is bonded to the active material P10 via the second electrolyte portion P12, and in particular, the active material P10 includes the positive electrode active material.

In the composite P100, the active material P10 may be unevenly distributed on one surface side. In this case, it is preferable that the composite P100 is in contact with the negative electrode 30 on a surface opposite to a side on which the active material P10 is unevenly distributed. When the active material P10 is unevenly distributed on the one surface side of the composite P100, the first electrolyte portion P11 and the third electrolyte portion P13 may be unevenly distributed on the other surface side.

A thickness of the composite P100 constituting the lithium-ion battery 100 is not particularly limited, but is preferably 0.1 μm or more and 500 μm or less, and more preferably 0.3 μm or more and 100 μm or less.

### 3-2 Negative Electrode

The negative electrode 30 may be any electrode that is formed of a so-called negative electrode active material that repeats electrochemical storage and discharging of lithium ions at a potential lower than that of the positive electrode active material constituting the composite P100.

The negative electrode 30 is formed of a material containing the negative electrode active material.

Examples of the negative electrode active material include a lithium double oxide such as Nb₂O₅, V₂O₅, TiO₂, In₂O₃, Zno, SnO₂, NiO, ITO, AZO, GZO, ATO, FTO, Li Ti₅O₁₂, and Li₂Ti₃O₇. Examples thereof further include metals and alloys such as Li, A1, Si, Si—Mn, Si—Co, Si—Ni, Sn, Zn, Sb, Bi, In, and Au, carbon materials, and substances in which the lithium ions are inserted between layers of the carbon materials LiC₂₄ and LiC₆.

In particular, the negative electrode 30 is preferably formed of metal Li.

Accordingly, it is possible to obtain an effect of accumulating electricity of about 10 times per weight and several times per volume as compared with a carbon negative electrode widely used in the lithium-ion battery.

A coating layer may be formed at the surface of the negative electrode active material to reduce an interface resistance with the solid electrolyte and to improve the electronic conductivity. A thickness of the coating layers is not particularly limited and is preferably 3 nm or more and 1 μm or less.

An average particle diameter of the negative electrode active materials is not particularly limited, and is preferably 0.1 μm or more and 150 μm or less, and more preferably 0.3 μm or more and 60 μm or less.

Accordingly, it is easy to achieve both an actual capacity density close to a theoretical capacity of the active material and a high charging and discharging rate.

A thickness of the negative electrode 30 is not particularly limited, and is preferably 0.1 μm or more and 500 μm or less, and more preferably 0.3 μm or more and 100 μm or less.

Examples of a method for forming the negative electrode 30 include a vapor deposition method such as a vacuum deposition method, a sputtering method, a CVD method, a PLD method, an ALD method, and an aerosol deposition method, and a chemical deposition method using a solution such as a sol-gel method and a MOD method. In addition, for example, fine particles of the negative electrode active material may be slurried together with an appropriate binder to form a coating film by squeegee or screen printing, and the coating film may be dried and fired to be baked at the surface of the composite P100.

### 3-3 Current Collector

The current collectors 41 and 42 are conductors provided to exchange electrons with the composite P100 severing as the positive electrode or the negative electrode 30. The current collectors 41 and 42 are usually formed of a material whose electrical resistance is sufficiently small and whose electrical conduction properties and mechanical structures do not substantially change due to charging and discharging.

Examples of a constituent material of the current collectors 41 and 42 include one type of metal selected from the group consisting of Cu, Mg, Ti, Fe, Co, Ni, Zn, A1, Ge, In, Au, Pt, Ag, and Pd and an alloy containing two or more types of metals selected from the group.

In particular, as the constituent material of the current collectors 41 and 42, Cu is preferred.

The current collectors 41 and 42 are usually provided to reduce contact resistances with the composite P100 and the negative electrode 30, respectively. Examples of a shape of the current collectors 41 and 42 include a plate shape and a mesh shape.

A thickness of the current collectors 41 and 42 is not particularly limited, and is preferably 7 μm or more and 85 μm or less, and more preferably 10 μm or more and 60 μm or less.

The lithium-ion battery 100 may not necessarily include the pair of current collectors 41 and 42, and may not include the current collector 42 as long as the current collector 41 is provided at at least one surface of the composite P100, that is, at a side opposite to the surface on which the negative electrode 30 as the electrode is provided.

For example, when a plurality of the lithium-ion batteries 100 are stacked to be electrically coupled in series, the lithium-ion battery 100 may include only the current collector 41 in the pair of current collectors 41 and 42.

### 4 Electronic Apparatus

Next, an electronic apparatus according to the present disclosure will be described.

The electronic apparatus according to the present disclosure includes the above-described battery according to the present disclosure.

Accordingly, it is possible to provide an electronic apparatus including the battery whose discharging capacity is less likely to decrease, and in particular, the discharging capacity is suitably maintained even when charging and discharging are repeated.

Examples of the electronic apparatus include a personal computer, a digital camera, a mobile phone, a smartphone, a music player, a tablet terminal, a watch, a smart watch, various printers such as an inkjet printer, a television, a projector, a head-up display, a wearable apparatus such as a wireless headphone, a wireless earphone, smart glasses, and a head mounted display, a video camera, a video tape recorder, a car navigation device, a drive recorder, a pager, an electronic notebook, an electronic dictionary, an electronic translator, a calculator, an electronic game device, a toy, a word processor, a workstation, a robot, a video phone, a security television monitor, electronic binoculars, a POS terminal, a medical device, a fish finder, various measurement devices, a vehicle base station device, various gauges for a vehicle, a railway vehicle, an aircraft, a helicopter, and a ship, a flight simulator, and a network server. The lithium-ion battery 100 may also be applied to a vehicle such as an automobile or a ship. More specifically, the lithium-ion battery 100 can be suitably applied as a storage battery for an electric vehicle, a plug-in hybrid vehicle, a hybrid vehicle, or a fuel cell vehicle. In addition, the lithium-ion battery 100 can be applied as a household power source, an industrial power source, a solar power storage battery, and the like.

Hereinafter, the wearable apparatus will be described as a specific example of the electronic apparatus according to the present disclosure.

FIG. 3 is a perspective view showing a configuration of the wearable apparatus as the electronic apparatus.

As shown in FIG. 3, a wearable apparatus 300 as the electronic apparatus is an information apparatus that is worn on, for example, a wrist WR of a human body like a wristwatch and is capable of acquiring information on the human body, and includes a band 301, a sensor 302, a display unit 303, a processing unit 304, and the lithium-ion battery 100.

The band 301 has a band shape in which a resin such as flexible rubber is used to be in close contact with the wrist WR at the time of wearing, and includes a coupling portion capable of adjusting a coupling position at an end portion of the band.

The sensor 302 is, for example, an optical sensor, and is disposed on an inner surface side of the band 301, that is, on a wrist WR side to be in contact with the wrist WR at the time of wearing.

The display unit 303 is, for example, a light receiving type liquid crystal display device, and is disposed on an outer surface side of the band 301, that is, on a side opposite to an inner surface to which the sensor 302 is attached such that a wearer can read information displayed on the display unit 303.

The processing unit 304 is, for example, an integrated circuit, is built in the band 301, and is electrically coupled to the sensor 302 and the display unit 303. The processing unit 304 performs calculation processing of measuring a pulse, a blood glucose level, and the like based on an output from the sensor 302. The display unit 303 is controlled to display measurement results and the like.

The lithium-ion battery 100 is built in the band 301 in a detachable state as a power supply source that supplies power to the sensor 302, the display unit 303, and the processing unit 304.

According to the wearable apparatus 300 of the embodiment, the information on the pulse and the blood glucose level of the wearer can be detected electrically by the sensor 302 from the wrist WR, and the pulse and the blood glucose level can be displayed on the display unit 303 through the calculation processing in the processing unit 304. Not only the measurement result but also, for example, information indicating a situation of the human body predicted based on the measurement result, time, and the like can also be displayed on the display unit 303.

In addition, since the lithium-ion battery 100 having a small size and excellent charging and discharging characteristics is used as the lithium-ion battery 100, it is possible to provide the wearable apparatus 300 that is lightweight, thin, and can withstand repeated use over long periods of time. In addition, since the lithium-ion battery 100 is a solid secondary battery, it is possible to provide the wearable apparatus 300 that can be used repeatedly by charging and can be safely used for long periods of time without concern of leakage of the electrolytic solution.

In the embodiment, the wearable apparatus 300 of a wristwatch type is described, and the wearable apparatus 300 may be worn, for example, on the ankle, head, ear, waist, or the like.

As described above, while the present disclosure has been described with reference to the preferred embodiment of the present disclosure, the present disclosure is not limited thereto.

For example, in the above-described embodiment, a case is described in which the composite includes the third electrolyte portions in addition to the active materials, the first electrolyte portions, and the second electrolyte portions, and the composite according to the present disclosure may not contain the third electrolyte portions.

The composite according to the present disclosure may be manufactured by any method and is not limited to being manufactured by the above-described method.

More specifically, in the above-described embodiment, a case is described in which the three heating treatment steps including the first heating treatment step, the second heating treatment step, and the third heating treatment step are performed. The number of heating treatment steps is not limited thereto, and the number of heating treatment steps may be reduced. Further, timings at which the heating treatment steps are performed are not limited to those described in the above-described embodiment.

In the above-described embodiment, a case is described in which the molten liquid of the third solid electrolyte is used to form the third electrolyte portion, and the third electrolyte portion may be formed by using the precursor of the third solid electrolyte.

In addition to the above-described steps, the composite according to the present disclosure may be manufactured by using a method further including another step.

The battery according to the present disclosure is not limited to the battery according to the above-described embodiment.

For example, the battery according to the above-described embodiment includes the composite which is the positive electrode active material and the negative electrode as the electrode, and the battery according to the present disclosure may contain the composite which is the negative electrode active material and the positive electrode as the electrode. The battery according to the present disclosure may contain two composites, and one composite may contain the positive electrode active material and the other composite may contain the negative electrode active material.

Further, in the above-described embodiment, the coin type battery is typically described, and the battery according to the present disclosure may have a shape other than the coin type.

### EXAMPLES

Next, specific examples according to the present disclosure will be described.

### 5 Manufacturing of Composite

### 5-1 Preparation of Solution of Metal Compound Used for Manufacturing of Solid Electrolyte

First, a solution of a metal compound used for manufacturing a solid electrolyte, particularly for manufacturing a first solid electrolyte and a second solid electrolyte, was prepared as follows.

5-1-1 Preparation of 2-n-Butoxyethanol Solution of Lithium Nitrate

Into a 30 g Pyrex reagent bottle (Pyrex: CORNING trademark. Pyrex is a registered trademark.) containing a magnetic stirrer, 1.3789 g of 3N5 lithium nitrate manufactured by Kanto Chemical Co. Inc. and 18.6211 g of Cica special grade 2-n-butoxyethanol (ethylene glycol monobutyl ether) manufactured by Kanto Chemical Co. Inc. were weighed. Next, the reagent bottle was placed on a hot plate having a magnetic stirrer function, lithium nitrate was completely dissolved in 2-n-butoxyethanol while being stirred at 170° C. for 1 hour, followed by gradual cooling to room temperature to obtain a 2-n-butoxyethanol solution of lithium nitrate with a concentration of 1 mol/kg.

5-1-2 Preparation of 2-n-Butoxyethanol Solution of Lanthanum Nitrate

Into a 30 g Pyrex reagent bottle (Pyrex: CORNING trademark. Pyrex is a registered trademark.) containing a magnetic stirrer, 8.6608 g of 4N lanthanum nitrate hexahydrate manufactured by Kanto Chemical Co. Inc. and 11.3392 g of Cica special grade 2-n-butoxyethanol manufactured by Kanto Chemical Co. Inc. were weighed. Next, the reagent bottle was placed on a hot plate having a magnetic stirrer function, lanthanum nitrate hexahydrate was completely dissolved in 2-n-butoxyethanol while being stirred at 140° C. for 30 minutes, followed by gradual cooling to room temperature to obtain a 2-n-butoxyethanol solution of lanthanum nitrate with a concentration of 1 mol/kg.

5-1-3 Preparation of 2-n-Butoxyethanol Solution of Zirconium Tetra-n-Butoxide

Into a 20 g Pyrex reagent bottle (Pyrex: CORNING trademark. Pyrex is a registered trademark.) containing a magnetic stirrer, 3.8368 g of zirconium tetra-n-butoxide manufactured by Kojundo Chemical Laboratory Co., Ltd. and 6.1632 g of Cica special grade 2-n-butoxyethanol manufactured by Kanto Chemical Co. Inc. were weighed. Next, the reagent bottle was placed on a hot plate having a magnetic stirrer function, and zirconium tetra-n-butoxide was completely dissolved in 2-n-butoxyethanol while being stirred at room temperature for 30 minutes to obtain a 2-n-butoxyethanol solution of zirconium tetra-n-butoxide with a concentration of 1 mol/kg.

### 5-1-4 Preparation of Ethyl Alcohol Solution of Gallium Nitrate

Into a 20 g Pyrex reagent bottle (Pyrex: CORNING trademark. Pyrex is a registered trademark.) containing a magnetic stirrer, 3.5470 g of gallium nitrate n-hydrate manufactured by Kojundo Chemical Laboratory Co., Ltd. and 6.4530 g of ethyl alcohol subjected to a dehydration treatment in advance were weighed, n being 5.5. Next, the reagent bottle was placed on a hot plate having a magnetic stirrer function, and gallium nitrate n-hydrate was completely dissolved in ethyl alcohol while being stirred at 90° C. for 1 hour, followed by gradual cooling to room temperature to obtain an ethyl alcohol solution of gallium nitrate with a concentration of 1 mol/kg, n being 5.5. The hydration number n of the used gallium nitrate n hydrate was 5.5 based on mass reduction results from a combustion experiment (differential thermal analysis).

5-1-5 Preparation of 2-n-Butoxyethanol Solution of Calcium Nitrate

Into a 20 g Pyrex reagent bottle (Pyrex: CORNING trademark. Pyrex is a registered trademark.) containing a magnetic stirrer, 2.3600 g of calcium nitrate tetrahydrate manufactured by Kanto Chemical Co. Inc. and 7.6400 g of 2-n-butoxyethanol subjected to a dehydration treatment in advance were weighed. Next, the reagent bottle was placed on a hot plate having a magnetic stirrer function, calcium nitrate tetrahydrate was completely dissolved in 2-n-butoxyethanol while being stirred at 100° C. for 30 minutes, followed by gradual cooling to room temperature to obtain a 2-n-butoxyethanol solution of calcium nitrate with a concentration of 1 mol/kg.

5-1-6 Preparation of 2-n-Butoxyethanol Solution of Niobium Penta-n-Butoxide

Into a 20 g Pyrex reagent bottle (Pyrex: CORNING trademark. Pyrex is a registered trademark.) containing a magnetic stirrer, 4.5848 g of niobium penta-n-butoxide manufactured by Kojundo Chemical Laboratory Co., Ltd. and 5.4152 g of Cica special grade 2-n-butoxyethanol manufactured by Kanto Chemical Co. Inc. were weighed. Next, the reagent bottle was placed on a hot plate having a magnetic stirrer function, and niobium penta-n-butoxide was completely dissolved in 2-n-butoxyethanol while being stirred at room temperature for 30 minutes to obtain a 2-n-butoxyethanol solution of niobium penta-n-butoxide with a concentration of 1 mol/kg.

5-1-7 Preparation of 2-n-Butoxyethanol Solution of Tantalum Pentaethoxide

Into a 20 g Pyrex reagent bottle (Pyrex: CORNING trademark. Pyrex is a registered trademark.) containing a magnetic stirrer, 5.4640 g of tantalum pentaethoxide manufactured by Kojundo Chemical Laboratory Co., Ltd. and 4.5360 g of Cica special grade 2-n-butoxyethanol manufactured by Kanto Chemical Co. Inc. were weighed. Next, the reagent bottle was placed on a hot plate having a magnetic stirrer function, and tantalum pentaethoxide was completely dissolved in 2-n-butoxyethanol while being stirred at room temperature for 30 minutes to obtain a 2-n-butoxyethanol solution of tantalum pentaethoxide with a concentration of 1 mol/kg.

5-1-8 Preparation of 2-n-Butoxyethanol Solution of Antimony Tri-n-Butoxide

Into a 20 g Pyrex reagent bottle (Pyrex: CORNING trademark. Pyrex is a registered trademark.) containing a magnetic stirrer, 3.4110 g of antimony tri-n-butoxide manufactured by Wako Pure Chemical Industries, Ltd. and 6.5890 g of Cica special grade 2-n-butoxyethanol manufactured by Kanto Chemical Co. Inc. were weighed. Next, the reagent bottle was placed on a hot plate having a magnetic stirrer function, and antimony tri-n-butoxide was completely dissolved in 2-n-butoxyethanol while being stirred at room temperature for 30 minutes to obtain a 2-n-butoxyethanol solution of antimony tri-n-butoxide with a concentration of 1 mol/kg.

### 5-2 Manufacturing of Composite

### Example A1

First, a composition for forming a second solid electrolyte and a composition for forming a first solid electrolyte were prepared by using the solutions prepared in 5-1.

The composition for forming the second solid electrolyte was prepared by mixing each of the solutions prepared in 5-1-1, 5-1-2, 5-1-3, 5-1-7, and 5-1-8 and Triton (registered trademark) X-100 (manufactured by MP Biomedicals, Inc.) as a nonionic surfactant at a predetermined proportion.

The composition for forming the first solid electrolyte was prepared by mixing each of the solutions prepared in 5-1-1, 5-1-2, 5-1-3, 5-1-4, and 5-1-5 and Triton (registered trademark) X-100 (manufactured by MP Biomedicals, Inc.) as a nonionic surfactant at a predetermined proportion.

A pellet of LiCoO₂ which is a positive electrode active material was placed on a hot plate via a silicon substrate. The pellet of LiCoO₂ was a rectangular parallelepiped having a size of 10 mm×10 mm×0.1 mm.

By using a micropipette, 15 μL of the composition for forming the second solid electrolyte was dropped onto the pellet of LiCoO₂. Accordingly, the composition for forming the second solid electrolyte permeates into an inside of the pellet of LiCoO₂ by a capillary phenomenon and spreads to cover the entire pellet.

Next, the temperature of the hot plate was raised to 90° C. and held for 15 minutes to volatilize the solvent of the composition for forming the second solid electrolyte.

Thereafter, the temperature of the hot plate was raised to 360° C. and held for 10 minutes to burn and decompose an organic component. The second precursor oxide having a crystal structure of a pyrochlore oxide was formed by such a heating treatment.

Thereafter, 20 μL of the composition for forming the first solid electrolyte was dropped onto the pellet of LiCoO₂ provided with the second precursor oxide by using a micropipette. Accordingly, the composition for forming the first solid electrolyte permeates into an inside of the pellet of LiCoO₂ provided with the second precursor oxide by a capillary phenomenon and spreads to cover the entire pellet.

Next, the temperature of the hot plate was raised to 90° C. and held for 15 minutes to volatilize the solvent of the composition for forming the first solid electrolyte.

Thereafter, the temperature of the hot plate was raised to 360° C. and held for 10 minutes to burn and decompose an organic component. The first precursor oxide having a crystal structure of a pyrochlore oxide was formed by such a heating treatment. The dropping of the composition for forming the first solid electrolyte, the volatilization of the solvent by heating, and the burning and decomposition of the organic component were performed 20 times in total.

Next, a firing treatment as the heating treatment at 900° C. for 8 hours was performed. Accordingly, the second precursor oxide became the second solid electrolyte, and the first precursor oxide became the first solid electrolyte. The second solid electrolyte had a composition of Li_{6.30}La₃Zr_{1.30}Sb_{0.50}Ta_{0.20}O₁₂ and had a cubic crystal garnet type crystal structure, and the first solid electrolyte had a composition of Li_{5.51}Ga_{0.50}La_{2.99}Ca_{0.01}Zr₂O₁₂ and had a cubic crystal garnet type crystal structure.

Next, as described above, the pellet of LiCoO₂ in which the second solid electrolyte and the first solid electrolyte were formed was impregnated with a molten liquid of Li_{2.2}O_{0.8}B_{0.2}O₃, which is the amorphous third solid electrolyte, followed by being cooled to room temperature to obtain the composite. A melting point of Li_{2.2}C_{0.8}B_{0.2}O₃, which is the third solid electrolyte, was 685° C., and a temperature of the molten liquid of the third solid electrolyte in the impregnation was 725° C.

### Examples A2 to A6

Except for adjusting a composition of the composition for forming the second solid electrolyte and a composition of the composition for forming the first solid electrolyte by adjusting a type and a use amount of the solutions prepared in 5-1, a composite was manufactured in the same manner as in Example A1.

### Example A7

Except that the amorphous third solid electrolyte was not applied after the firing treatment at 900° C. for 8 hours, a composite was manufactured in the same manner as in Example A3. That is, the composite according to the present example includes the active materials, the first electrolyte portions, and the second electrolyte portions, and does not include the third electrolyte portions.

### Example A8

First, a composition for forming a second solid electrolyte and a composition for forming a first solid electrolyte were prepared by using the solutions prepared in 5-1.

The composition for forming the second solid electrolyte was prepared by mixing each of the solutions prepared in 5-1-1, 5-1-2, 5-1-3, 5-1-7, and 5-1-8 and Triton (registered trademark) X-100 (manufactured by MP Biomedicals, Inc.) as a nonionic surfactant at a predetermined proportion.

The composition for forming the first solid electrolyte was prepared by mixing each of the solutions prepared in 5-1-1, 5-1-2, 5-1-3, 5-1-4, and 5-1-5 and Triton (registered trademark) X-100 (manufactured by MP Biomedicals, Inc.) as a nonionic surfactant at a predetermined proportion.

The composition for forming the second solid electrolyte was put into a Pyrex reagent bottle (Pyrex: CORNING trademark. Pyrex is a registered trademark.), and here, a powder of LiCoO₂ which is a positive electrode active material was added. An average particle diameter of the powder of LiCoO₂ was 5.5 μm.

The reagent bottle was immersed in an ultrasonic cleaner containing water to apply ultrasonic waves to disperse the powder of LiCoO₂.

Thereafter, the excessive composition for forming the second solid electrolyte was removed by using a centrifugal separator, and the powder of LiCOO₂ with the composition for forming the second solid electrolyte adhering to a surface thereof was transferred to a titanium petri dish having an inner diameter of 50 mm and a depth of 20 mm and heated on a hot plate. A solvent contained in the composition for forming the second solid electrolyte was volatilized by being heated at 90° C. for 30 minutes, followed by being heated at 360° C. for 30 minutes to burn and decompose an organic component. The second precursor oxide having a crystal structure of a pyrochlore oxide was formed by such a heating treatment.

Thereafter, the powder of LiCoO₂ coated with the second precursor oxide as described above was added into the Pyrex reagent bottle (Pyrex: CORNING trademark. Pyrex is a registered trademark.) in which the composition for forming the first solid electrolyte was added.

The reagent bottle was immersed in an ultrasonic cleaner containing water to apply ultrasonic waves to disperse the powder of LiCoO₂ covered with the second precursor oxide.

Thereafter, the excessive composition for forming the first solid electrolyte was removed by using a centrifugal separator, and the powder of LiCOO₂ coated with the second precursor oxide in which the composition for forming the first solid electrolyte adheres to a surface thereof was transferred to a titanium petri dish having an inner diameter of 50 mm and a depth of 20 mm and heated on a hot plate. A solvent contained in the composition for forming the first solid electrolyte was volatilized by being heated at 90° C. for 30 minutes, followed by being heated at 360° C. for 30 minutes to burn and decompose an organic component. The first precursor oxide having a crystal structure of a pyrochlore oxide was formed by such a heating treatment.

Next, the powder of LiCoO₂ coated with the second precursor oxide and the first precursor oxide was pressurized for 2 minutes at a pressure of 624 MPa by using a mold with an exhaust port having an inner diameter of 10 mm, followed by obtaining a disk-shaped molded product having a diameter of 10 mm, an effective diameter of 8 mm, and a thickness of 150 μm.

The disk-shaped molded product obtained in this way was subjected to the firing treatment, which was a heating treatment at 900° C. for 8 hours, and thus the second precursor oxide became the second solid electrolyte and the first precursor oxide became the first solid electrolyte. The second solid electrolyte had a composition of Li_{6.30}La₃Zr_{1.30}Sb_{0.50}Ta_{0.20}O₁₂ and had a cubic crystal garnet type crystal structure, and the first solid electrolyte had a composition of Li_{5.51}Ga_{0.50}La_{2.99}Ca_{0.01}Zr₂O₁₂ and had a cubic crystal garnet type crystal structure.

Next, as described above, the disk-shaped molded product in which the second solid electrolyte and the first solid electrolyte were formed was impregnated with a molten liquid of Li_{2.2}C_{0.8}B_{0.2}O₃, which is the amorphous third solid electrolyte, followed by being cooled to room temperature to obtain the composite. A melting point of Li_{2.2}C_{0.8}B_{0.2}O₃, which is the third solid electrolyte, was 685° C., and a temperature of the molten liquid of the third solid electrolyte in the impregnation was 725° C.

### Examples A9 to A12

Except for adjusting a composition of the composition for forming the second solid electrolyte and a composition of the composition for forming the first solid electrolyte by adjusting a type and a use amount of the solutions prepared in 5-1, a composite was manufactured in the same manner as in Example A8.

### Example A13

Except that the amorphous third solid electrolyte was not applied after the firing treatment at 900° C. for 8 hours, a composite was manufactured in the same manner as in Example A10. That is, the composite according to the present example includes the active materials, the first electrolyte portions, and the second electrolyte portions, and does not include the third electrolyte portions.

### Example A14

First, a composition for forming a second solid electrolyte and a composition for forming a first solid electrolyte were prepared by using the solutions prepared in 5-1.

The composition for forming the second solid electrolyte was prepared by mixing each of the solutions prepared in 5-1-1, 5-1-2, 5-1-3, 5-1-7, and 5-1-8 and Triton (registered trademark) X-100 (manufactured by MP Biomedicals, Inc.) as a nonionic surfactant at a predetermined proportion.

The composition for forming the first solid electrolyte was prepared by mixing each of the solutions prepared in 5-1-1, 5-1-2, 5-1-3, 5-1-4, and 5-1-5 and Triton (registered trademark) X-100 (manufactured by MP Biomedicals, Inc.) as a nonionic surfactant at a predetermined proportion.

A LiCOO₂ chip (manufactured by Toshima Manufacturing Co., Ltd., 50 mm square, 1 mm thickness), which is the positive electrode active material, was prepared, and the composition for forming the second solid electrolyte was applied from one surface side by using a doctor blade. Accordingly, the composition for forming the second solid electrolyte permeates into an inside of the LiCOO₂ chip by a capillary phenomenon and spreads to cover the entire chip.

Next, the LiCoO₂ chip coated with the composition for forming the second solid electrolyte was placed on a hot plate via a silicon substrate, the temperature of hot plate was raised to 90° C. and held for 15 minutes, and the solvent of the composition for forming the second solid electrolyte was volatilized.

Thereafter, the temperature of the hot plate was raised to 360° C. and held for 10 minutes to burn and decompose an organic component. The second precursor oxide having a crystal structure of a pyrochlore oxide was formed by such a heating treatment.

Thereafter, the composition for forming the first solid electrolyte was coated from the one surface side of the LiCoO₂ chip on which the second precursor oxide was formed as described above by using a doctor blade. Accordingly, the composition for forming the first solid electrolyte permeates into an inside of the LiCoO₂ chip by a capillary phenomenon and spreads to cover the entire chip.

Next, the temperature of the hot plate was raised to 90° C. and held for 15 minutes to volatilize the solvent of the composition for forming the first solid electrolyte.

Thereafter, the temperature of the hot plate was raised to 360° C. and held for 10 minutes to burn and decompose an organic component. The first precursor oxide having a crystal structure of a pyrochlore oxide was formed by such a heating treatment.

Next, a firing treatment as the heating treatment at 900° C. for 8 hours was performed. Accordingly, the second precursor oxide became the second solid electrolyte, and the first precursor oxide became the first solid electrolyte. The second solid electrolyte had a composition of Li_{6.30}La₃Zr_{1.30}Sb_{0.50}Ta_{0.20}O₁₂ and had a cubic crystal garnet type crystal structure, and the first solid electrolyte had a composition of Li_{5.51}Ga_{0.50}La_{2.99}Ca_{0.01}Zr₂O₁₂ and had a cubic crystal garnet type crystal structure.

Next, as described above, the LiCoO₂ chip at which the second solid electrolyte and the first solid electrolyte were formed was impregnated with a molten liquid of Li_{2.2}C_{0.8}B_{0.2}O₃, which is the amorphous third solid electrolyte, followed by being cooled to room temperature to obtain the composite. A melting point of Li_{2.2}C_{0.8}B_{0.2}O₃, which is the third solid electrolyte, was 685° C., and a temperature of the molten liquid of the third solid electrolyte in the impregnation was 725° C.

### Examples A15 to A18

Except for adjusting a composition of the composition for forming the second solid electrolyte and a composition of the composition for forming the first solid electrolyte by adjusting a type and a use amount of the solutions prepared in 5-1, a composite was manufactured in the same manner as in Example A14.

### Example A19

Except that the amorphous third solid electrolyte was not applied after the firing treatment at 900° C. for 8 hours, a composite was manufactured in the same manner as in Example A16. That is, the composite according to the present example includes the active materials, the first electrolyte portions, and the second electrolyte portions, and does not include the third electrolyte portions.

### Comparative Example A1

Except that the step of applying the composition for forming the second solid electrolyte to the positive electrode active material and the step of forming the second precursor oxide by the heating treatment for the positive electrode active material to which the composition for forming the second solid electrolyte was applied were omitted, a composite was manufactured in the same manner as in Example A3. That is, the composite according to the present comparative example includes the active materials, the first electrolyte portions, and the third electrolyte portions, and does not include the second electrolyte portions.

### Comparative Example A2

Except that the amorphous third solid electrolyte was not applied after the firing treatment at 900° C. for 8 hours, a composite was manufactured in the same manner as in Comparative Example A1. That is, the composite according to the present comparative example includes the active materials and the first electrolyte portions, and does not include the second electrolyte portions and the third electrolyte portions.

### Comparative Example A3

Except for adjusting a composition of the composition for forming the first solid electrolyte by adjusting a type and a use amount of the solutions prepared in 5-1, a composite was manufactured in the same manner as in Comparative Example A1. Comparative Example A4

Except that a coating film formed of LiAlO₂ was formed instead of the second solid electrolyte having a composition of Li_{5.75}La₃Zr_{0.75}Nb_{0.35}Sb_{0.50}Ta_{0.40}O₁₂, a composite was manufactured in the same manner as in Example A4.

The formation of the coating film formed of LiAlO₂ was performed in the same manner as in Example A1, except that a composition for forming LiAlO₂ was used instead of the composition for forming the second solid electrolyte.

### Comparative Examples A5 to A12

Except for adjusting a composition of the composition for forming the first solid electrolyte by adjusting a type and a use amount of the solutions prepared in 5-1 and the heating temperature in the firing treatment, a composite was manufactured in the same manner as in Example A1.

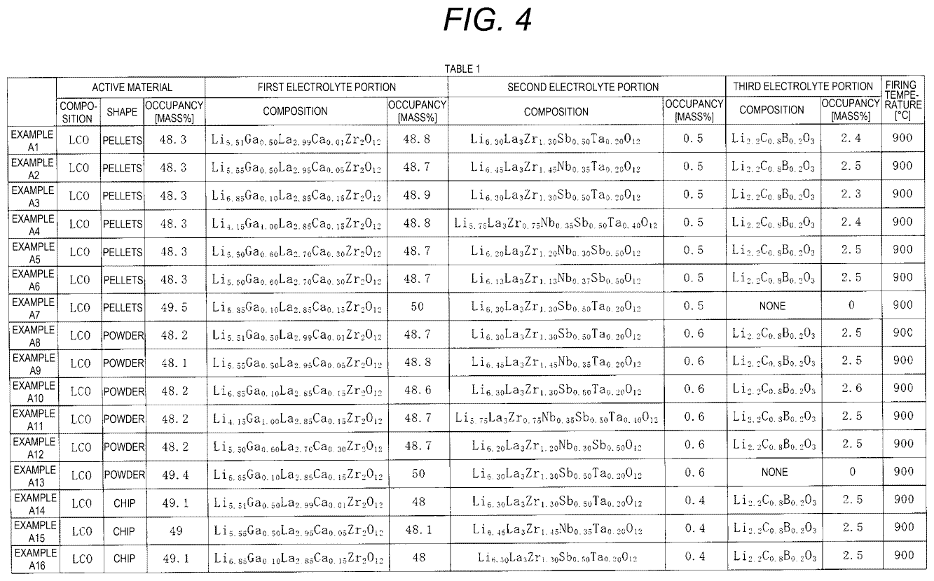

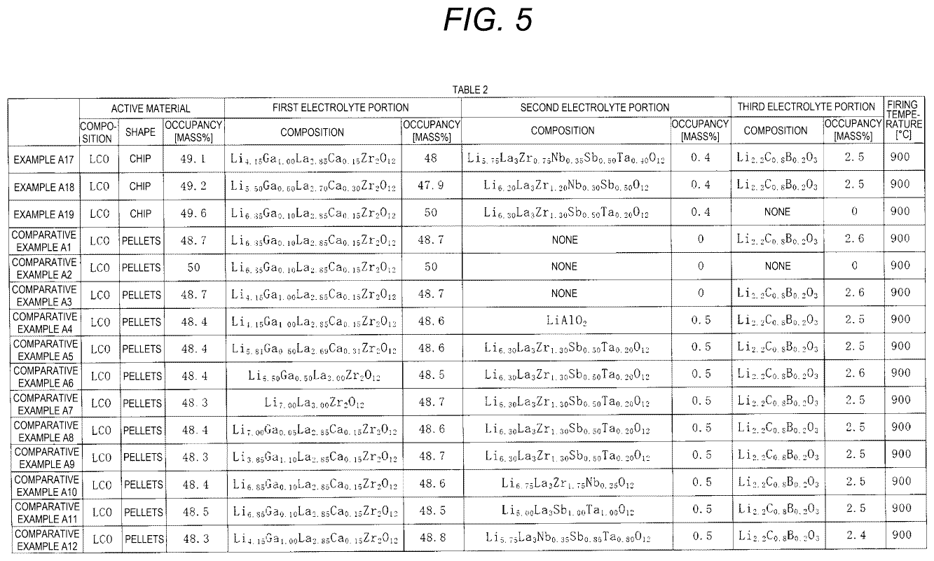

The conditions of the composite of each of Examples and Comparative Examples and the heating temperature in the firing treatment, that is, a firing temperature are collectively shown in FIGS. 4 and 5. In FIGS. 4 and 5, LiCOO₂ was indicated as “LCO”, and the proportion of each portion constituting the composite in the composite was indicated as “occupancy”. In each of the composites obtained in Examples and Comparative Examples, the content of the solvent was 0.1 mass % or less, and the content of the oxo anion was 100 ppm or less. In each of Examples, the crystal grain diameters of the first precursor oxide and the second precursor oxide formed in the steps of manufacturing the composite were values all within a range of 20 nm or more and 160 nm or less. Further, in each of the composites obtained in Examples, the second electrolyte portion was formed in a film shape at the surface of the positive electrode active material, and the average thickness of the second electrolyte portion was a value in a range of 0.004 μm or more and 0.080 μm or less.

### 6 Evaluation of Composite

The composite of each of Examples and Comparative Examples obtained described above was evaluated for lithium-ion conductivity as an index of lithium-ion conductivity by the following method.

That is, a lithium electrode (ion activation electrode) of 8 mmφ was produced by lithium vapor deposition on both front and back surfaces of the composite. Next, AC impedance measurement was performed by using an impedance analyzer SI1260 (manufactured by Solartron). An AC amplitude at the time of measurement was 10 mV, and a measurement frequency was 107 Hz to 10-1 Hz.

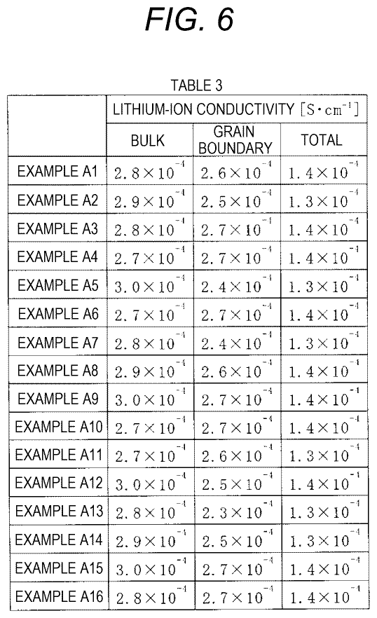

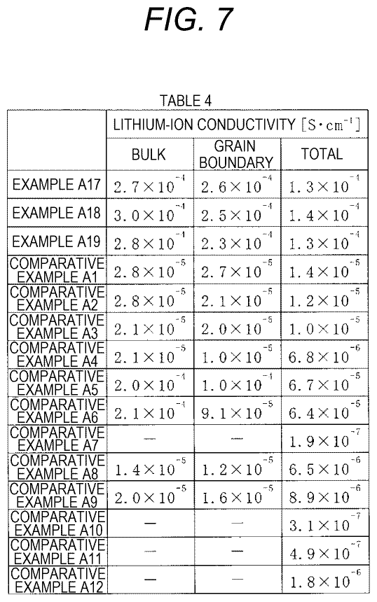

The results are collectively shown in FIGS. 6 and 7.

As presented in FIGS. 6 and 7, Examples according to the present disclosure produced satisfactory results, while the Comparative Examples did not.

### 7 Manufacturing of Battery

### Example B1

A lithium negative electrode was formed at one surface of the composite manufactured in Example A1 by a vacuum deposition method. A thickness of the formed negative electrode was 20 μm.

Next, by forming copper current collectors on both surfaces of a stacking body of the composite and the negative electrode by a vacuum sputtering method, a battery was obtained. A thickness of the current collector was 10 μm.

### Examples B2 to B19

Except that the composites manufactured in Examples A2 to A19 were used as the composite, batteries were manufactured in the same manner as in Example B1.

### Comparative Examples B1 to B12

Except that the composites manufactured in Comparative Examples A1 to A12 were used as the composite, batteries were manufactured in the same manner as in Example B1.

### 8 Evaluation of Battery

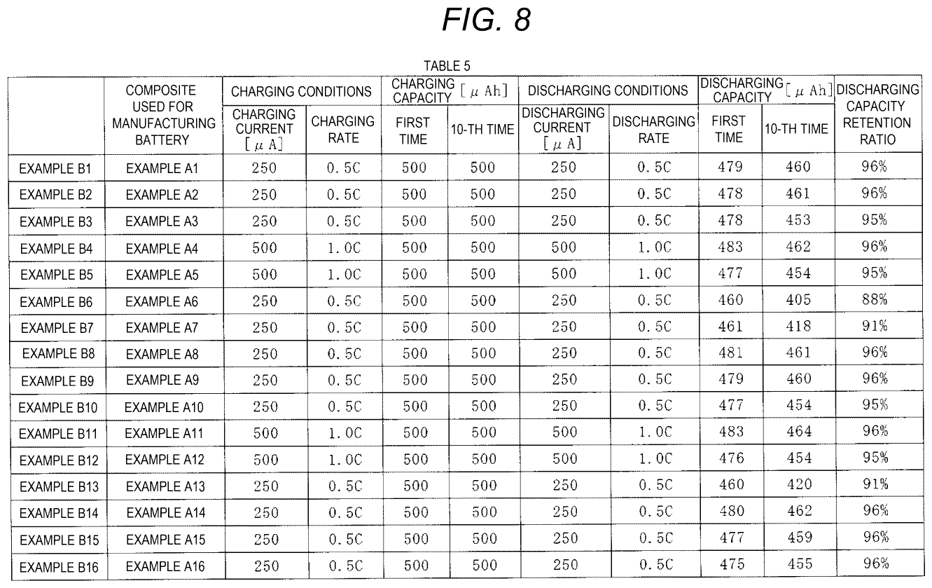

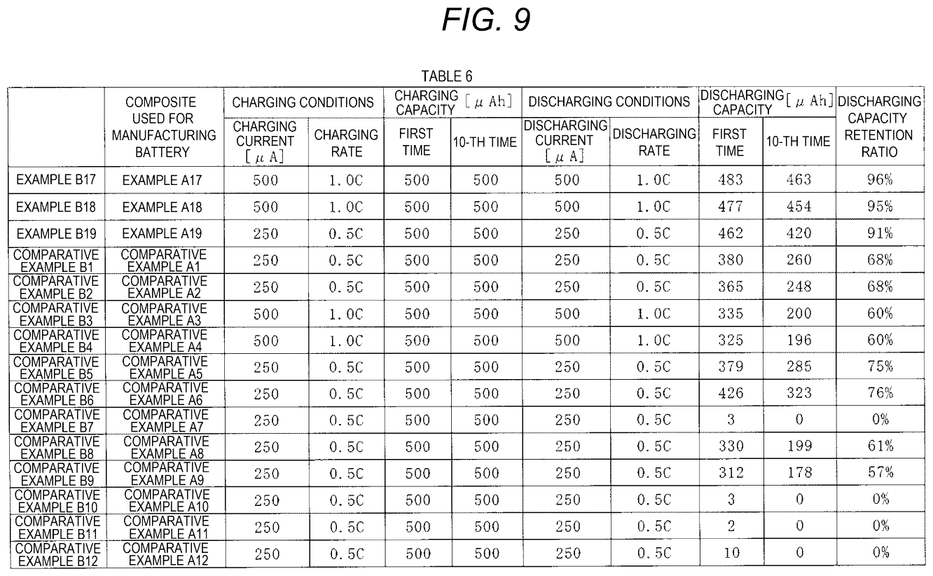

The batteries in Examples B1 to B19 and Comparative Examples B1 to B12 obtained as described above were coupled to a battery charging and discharging evaluation system HJ1001SD8 manufactured by Hokuto Denko Corp. immediately after manufacturing, and the charging and discharging were repeated under the conditions shown in FIGS. 8 and 9 to evaluate the charging and discharging characteristics of the battery for the first and 10-th times.

The results are collectively shown in FIGS. 8 and 9, together with the charging and discharging conditions. The “discharging capacity retention ratio” in FIGS. 8 and 9 indicates a ratio of the 10-th discharging capacity to the first discharging capacity.

As presented in FIGS. 8 and 9, Examples according to the present disclosure produced satisfactory results, while the Comparative Examples did not.

What is claimed is:

1. A composite comprising:
an active material;
a crystalline first electrolyte portion containing a lithium composite metal oxide represented by the following composition formula (1); and
a second electrolyte portion containing a lithium composite metal oxide represented by the following composition formula (2) and configured to cover at least a part of a surface of the active material, wherein
at least a part of the first electrolyte portion is bonded to the active material through the second electrolyte portion,
(Li_{7-3x+y}Gaₓ) (La_{3-y}Ca_{y}) Zr₂O₁₂ (1)
in which 0.10≤x≤1.00, and 0.00<y≤0.30, and
Li_{7-z}La₃(Zr_{2-z}M_{z})O₁₂ (2)
in which the element M is two or more elements selected from the group consisting of Nb, Ta, and Sb, and 0.00<z<2.00.

2. The composite according to claim 1, further comprising:
an amorphous third electrolyte portion in contact with the first electrolyte portion and containing Li.

3. The composite according to claim 2, wherein the third electrolyte portion contains Li, B, and O.

4. The composite according to claim 1, wherein the active material is a positive electrode active material containing Li.

5. A battery comprising:
the composite according to claim 1;
an electrode provided on one surface side of the composite; and
a current collector provided on the other surface side of the composite.

6. An electronic apparatus comprising:
the battery according to claim 5.
